(19) United States
(12) Patent Application Publication
(10) Pub. No.: US 2010/0042796 A1
(43) Pub. Date: Feb. 18, 2010

(54) Updation of Disk Images to Facilitate Virtualized Workspaces in a Virtual Computing Environment

(75) Inventors: Alex David Vasilevsky, Westford, MA (US); Thomas Carl Goetz, Hopkinton, MA (US); Douglas Copeland Lane, Westport, MA (US); Daniel Robert McCall, Westford, MA (US); Nils Atticus Nieuwejaar, Bedford, MA (US)

Correspondence Address: THE WEBB LAW FIRM, P.C., 700 KOPPERS BUILDING, 436 SEVENTH AVENUE, PITTSBURGH, PA, 15219, US

(73) Assignee: VIRTUAL COMPUTER, INC., Westford, MA (US)

(21) Appl. No.: 12/604,662

(22) Filed: Oct. 23, 2009

Related U.S. Application Data
(63) Continuation of application No. 12/338,452, filed on Dec. 18, 2008.
(60) Provisional application No. 61/015,281, filed on Dec. 20, 2007.

(51) Int. Cl. G06F 12/00; G06F 12/16; G06F 9/455

(52) U.S. Cl. 711/162; 718/1

(57) ABSTRACT

The present invention provides methods and systems for updating one or more virtualized workspaces. The one or more virtualized workspaces may be facilitated by cloning a master root disk image, and then applying temporary personalization to the master root disk image clone. The master root image clone may then be published to one or more of the users by omitting one or more portions of the personalization. Furthermore, re-personalization of a user's copy of the published master root disk image clone may be provided for use on the local computer of the user; re-personalization of a user's copy may be based at least in part on the clone.

### CROSS-REFERENCE TO RELATED APPLICATIONS

This application is a continuation of U.S. patent application Ser. No. 12/338,452, filed Dec. 18, 2008 which claims the benefit of U.S. Provisional Patent Application Ser. No. 61/015,281, filed Dec. 20, 2007.

This application is related to the following co-pending patent applications, each of which is incorporated herein in its entirety: U.S. patent application Ser. No. 12/435,625, filed May 5, 2009; U.S. patent application Ser. No. 12/435,685, filed May 5, 2009; and U.S. patent application Ser. No. 12/435,775, filed May 5, 2009.

### BACKGROUND OF THE INVENTION

1. Field of the Invention

This patent application relates to the field of computing and more particularly to the field of virtualized computing management.

2. Description of Related Art

Personal computers run instances of operating systems within which instances of applications execute. In some personal computers, virtualization facilities enable substantially concurrent yet isolated operation of a plurality of operating systems, each of which runs on a virtual machine. The virtualization facilities can include virtualization software, hardware-based virtualization, a combination of the foregoing, and so on.

Tasks like managing and updating the operating systems and applications necessarily occur at each of the personal computers. Updating occurs via software updates that are distributed and applied to each of the personal computers. Managing is performed by users/administrators who configure security settings or other preferences at each of the personal computers.

As a result of the distributed nature of managing and updating operating systems and applications, software conflicts or configuration errors also occur in a distributed fashion.

There remains a need for systems and methods that employ centrally managed and centrally updated virtual machine images that are distributed to and executed on personal computers.

### SUMMARY OF THE INVENTION

Embodiments of the present invention contain systems and methods that employ centrally managed and centrally updated virtual machine images that are distributed to and executed on personal computers.

In one aspect, a method of providing a virtualized workspace associated with a computer having an operating system that is disclosed herein includes providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications. The full virtualization facility for abstracting the computer's hardware may use a hypervisor.

In one aspect, a method that is disclosed herein includes delivering a virtualized workspace to a computer, wherein the virtualized workspace comprises a virtual machine disk image. The virtualized workspace may include an operating system, applications and end user data encapsulated and packaged as a virtual machine image. Delivering the virtualized workspace may further include providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications.

In one aspect, a method that is disclosed herein includes providing a plurality of virtualized workspaces for operating on the same computer, each workspace embodied in at least one virtual machine disk image; providing shared management of a first workspace by using a root disk image adapted for use by a plurality of users of a plurality of centrally managed desktops; and allowing local management of a second workspace, the management of the second workspace not being subject to at least one constraint applicable to the first workspace. The shared management may be centralized management. Providing shared management of the first workspace may include allowing local management of the first workspace. Local management of the first workspace may produce a modification to the root disk image. Local management of the first workspace may produce changes to the first workspace that are retained even when the root disk image is later updated. The local management may allow customization of the second workspace by the end user. The desktops may correspond to desktop computing environments of a plurality of users.

In one aspect, a method that is disclosed herein includes providing a plurality of virtualized workspaces for operating on the same computer, each workspace embodied in at least one a virtual machine disk image; and providing an integrated security facility for managing security with respect to at least a plurality of the virtualized workspaces. The integrated security facility may allow full management of security of an operating system from outside the operating system. The integrated security facility may allow management of the memory of an operating system from outside the operating system. The integrated security facility may allow management of an operating system from outside the operating system using a hypervisor.

In one aspect, a method that is disclosed herein includes providing a facility for managing a virtualized workspace adapted to operate on a computer; and embodying the virtualized workspace as a set of virtual disk images to facilitate transporting the workspace to a second computer for operation of the workspace without necessitating installation of an operating system component on the second computer.

In one aspect, a method that is disclosed herein includes providing a facility for managing a virtualized workspace adapted to operate on a computer; and embodying the virtualized workspace as a set of virtual disk images to facilitate transporting the workspace to a second computer independent of the configuration of the hardware of the second computer.

In one aspect, a method of providing a virtualized workspace associated with a computer having an operating system that is disclosed herein includes providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; providing a user data virtualization facility for containing and isolating user data from the hardware, the operating system and the applications; using a server to provide remote access to a virtualized workspace on a client device.

In one aspect, a method of providing a virtualized workspace associated with a computer having an operating system that is disclosed herein includes providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; providing a user data virtualization facility for containing and isolating user data from the hardware, the operating system and the applications; and providing a backup facility to allow instant, hardware-agnostic access to the virtualized workspace. The backup facility may be a remote backup facility. The backup facility may be a local backup facility.

In one aspect, a method of updating a plurality of virtualized workspaces that is disclosed herein includes creating a clone of a master root disk image; applying temporary personalization to the clone of the master root disk image; publishing the updated master root image to a plurality of users, wherein publishing omits at least a portion of the personalization applied to the clone of the master root disk image; and based at least in part on the clone, re-personalizing a user's copy of the published master root disk image for use on the user's local computer.

In one aspect, a method of re-personalizing a user's copy of a published master root disk that is disclosed herein includes receiving a master root disk image; injecting a personality into the master root disk image; and utilizing the master root disk image to provide a personalized workspace. Injecting the personality may include modifying a parameter embodied in the master root disk image, the parameter selected from a group of parameters consisting of a computer name, a user account identifier, a system identifier, and a hard variable of an operating system.

In one aspect, a method of providing a virtualized workspace associated with a computer having an operating system that is disclosed herein includes providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; providing a user data virtualization facility for containing and isolating user data from the hardware, the operating system and the applications; providing a backup facility to allow instant, hardware-agnostic access to the virtualized workspace; and providing a disposal facility for disposing of the entire virtualized workspace. The disposing may be in response to user action. The disposing may be upon expiration of a time period. The disposing may be based on a policy. The disposing may be triggered upon violation of a policy.

In one aspect, a method of updating a virtualized workspace associated with a computer having an operating system that is disclosed herein includes embodying a virtualized workspace in a master root disk image; updating the master root disk image; and deploying the master root disk image to a plurality of computers. Virtualizing the workspace may include providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications.

In one aspect, a method that is disclosed herein includes accessing a virtualized workspace; and delivering the virtualized workspace by streaming data from a central computer to a remote computer for use of the virtualized workspace on the remote computer. Delivering the virtualized workspace may include delivering a full virtualization facility for abstracting the computer's hardware from the operating system and from applications running on the computer; delivering an operating system virtualization facility for containing and isolating operating system services from each other and applications; delivering an application virtualization facility for allowing at least one application to run virtualized on an operating system of the computer; and delivering a user data virtualization facility for containing and isolating user data from the hardware, the operating system and the applications.

In one aspect, a system that is disclosed herein includes a central computer; a file system operatively coupled to the central computer; and data stored in the file system, the data adapted for use on a remote computer to provide a virtualized workspace on the remote computer, wherein the remote computer is operatively coupled to the file system. The file system may include a file system selected from a group of file systems consisting of a SAN file system, a Network File System, and a Common Internet File System.

In one aspect, a method of providing a virtualized workspace associated with a mobile computer having an operating system that is disclosed herein includes providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications. The mobile computer may be a laptop computer. The mobile computer may be a handheld computer. The mobile computer may be a smart phone. The mobile computer may be a point of sale device.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

The invention and the following detailed description of certain embodiments thereof may be understood by reference to the following figures:

FIG. 1 depicts virtual workspaces management architecture.

FIG. 2 depicts a virtual workspace specification.

FIG. 3 depicts a user interface of a workspaces execution engine.

FIG. 4 depicts a user interface of a workspaces execution engine.

FIG. 5 depicts data volumes and a trusted boot sequence.

FIG. 6 depicts a set of platform configuration registers.

FIG. 7 depicts a key hierarchy.

FIG. 8 depicts a workspaces execution engine architecture.

FIG. 9 depicts a method of providing a virtualized workspace.

FIG. 10 depicts a method of delivering a virtualized workspace.

FIG. 11 depicts a method of providing security for virtualized workspaces.

FIG. 12 depicts a method of embodying a virtualized workspace.

FIG. 13 depicts a method of embodying a virtualized workspace.

FIG. 14 depicts a method of providing a virtualized workspace.

FIG. 15 depicts a method of providing a virtualized workspace.

FIG. 16 depicts a method of providing a virtualized workspace.

FIG. 17 depicts a method of updating a plurality of virtualized workspaces.

FIG. 18 depicts a method of providing a virtualized workspace.

FIG. 19 depicts a method of updating a virtualized workspace.

FIG. 20 depicts a method of delivering a virtualized workspace.

FIG. 21 depicts a method of providing a virtualized workspace.

FIG. 22 depicts a method of personalizing a master root disk image.

FIG. 23 depicts a system that provides a virtualized workspace.

### DETAILED DESCRIPTION OF THE INVENTION

Embodiments deliver an operating system and software applications to a personal computer. The operating system and software applications may be managed and configured at a central location prior to delivery. User data or a system disk image that is created or modified on the personal computer by the operating system or applications may, from time to time, be stored at the central location. When a user switches from one personal computer to another, the user's data may be transferred from the central location to the user's current computer. Additionally, the user's current computer may receive suitable versions of the operating system and applications from the central location. In any case, the operating system and software applications may run with a domain of execution that is provided by a hypervisor. Thus, the operating system and software applications may operate within a virtualized machine, perhaps alongside and in isolation from other operating systems and software applications.

Throughout this disclosure, a “workspace” or “virtual workspace” may refer to a collection of system data, user data, and virtualized applications, metadata and policies. In some cases, the workspace or virtual workspace may be characterized by an environment definition (that is, an execution environment meeting software requirements of a user) and a resource allocation that includes CPU, memory, and network bandwidth allocation parameters. In embodiments the workspace or virtual workspace may include software such as an operating system and one or more applications, in addition to user data, any number of policies, and so on. In embodiments, the operating systems may be configured for use and fully updated with patches, bug fixes, and the like. Since the workspace may contain a pre-installed operating system, execution of the workspace on a personal computer may proceed without performing an operating system installation process on the personal computer. In embodiments, the policies may be pre-configured and may include security policies, usage policies, application and system preferences, and the like. In some embodiments, the operating system may include any and all versions of the following operating systems, including without limitation equivalents or derivatives thereof: Microsoft Windows, Unix, Linux, Mac OS X, and so on.

When a copy of a workspace is run on a suitable personal computer, that copy of the workspace may produce a user experience. In some embodiments, the user experience may be a substantially conventional user experience. For example, the user experience may be one in which a user runs the applications within a windowed, graphical user interface that is provided by the operating system. For another example, the user experience may be one in which a user runs applications from a command-line or console within a textual user interface that is provided by the operating system.

The suitable personal computer (herein, “personal computer”) may be a computer having within it a virtualization software framework, which includes a hypervisor and a privileged virtual machine that runs a Workspaces Execution Engine (WEE). In embodiments, the WEE may download, cache, and run a copy of a workspace in addition to backing up copies of the workspace's user data or system disk image to a network repository or the like. The privileged virtual machine may run within privileged domain of execution, which may be variously referred to in the art as a “control domain” or “DOM zero.”

In some embodiments, the WEE may utilize what is known in the art as a Trusted Platform Module (TPM) or the like to attest to the security or authenticity of the WEE software, of the workspace, and so on.

In some embodiments the WEE may provide a suite of management functions including, without limitation, disk imaging, machine lockdown, software updates, backups, systems and data recovery, mobile computing functions (e.g., for energy saver functions, network roaming functions, and so on), caching, pre-fetching, streaming, and so on. Additional management functions may be described herein, and still others will be appreciated. All such management functions are within the scope of the present disclosure.

It should be understood that the hypervisor may manage the execution of the privileged domain and any number of non-privileged domains (referred to in the art as “guest domains”). It should also be understood that the hypervisor may provide total isolation between the domains while also providing each domain with access to common underlying resource. Without limitation such resources may include disk, CPU, network, and so on. In some embodiments, all or part of the hypervisor may be implemented in hardware, or may rely on built-in hardware virtualization functions. In some embodiments the hypervisor may be software-based and may depend upon some or all of the operating systems being patched to support virtualization. It will be understood that a variety of embodiments of the hypervisor are possible. All such embodiments are within the scope of the present disclosure.

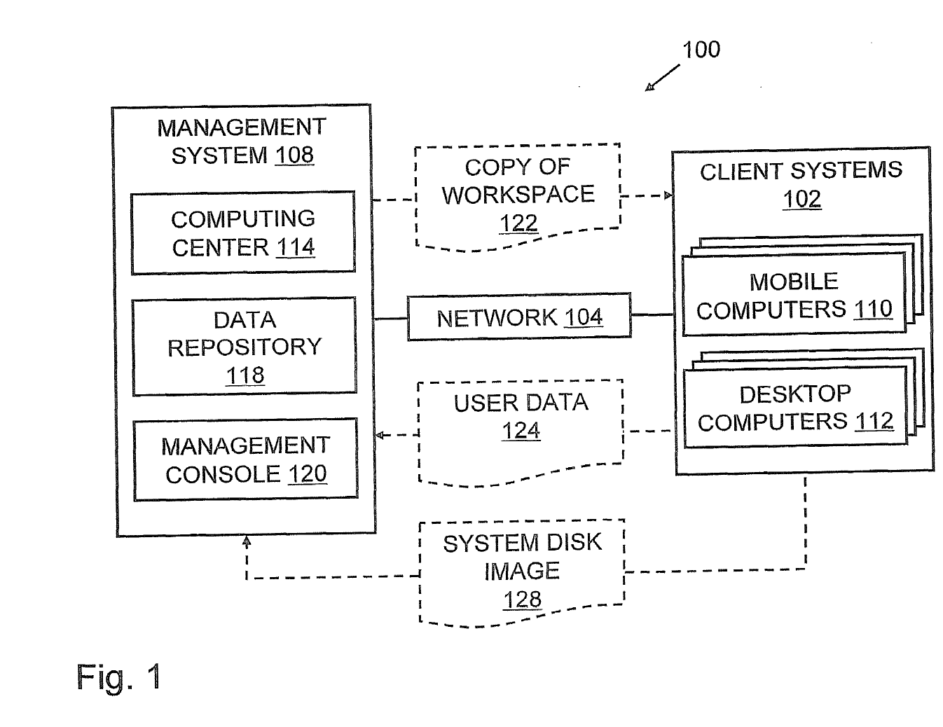

FIG. 1 depicts virtual workspaces management architecture. The architecture 100 includes client systems 102, a network 104, and a management system 108. The client systems 102 include a plurality of mobile computers 110 and a plurality of desktop computers 112. The management system 108 includes a computing center 114 and a data repository 118. The computing center 114 provides a web-based management console 120, a command-line interface, or the like.

The client systems 102 may from time to time communicate with the management system 108 via the network 104. In embodiments, the clients systems 102 may have constant, intermittent, or no connectivity to the network 104. It will be understood that a variety of systems and methods for providing this connectivity are possible. In any case, this connectivity may enable communications between the client systems 102 and the management system 108.

Each of the client systems 102 may include a suitable personal computer or the like running a WEE. Communications between the client systems 102 and the management system 108 may enable certain operations of the WEE. For example and without limitation, the communications may include downloading a copy of a workspace 122 from the management system 108, uploading user data 124 to the management system 108, uploading a system disk image 128 to the management system 108, and so on. A variety of other such communications will be understood. All such communications are within the scope of the present disclosure.

In embodiments, the client systems 102 may execute the copy of the workspace 122 within a virtual machine. Thus, in embodiments each of the client systems 102 may include multiple workspaces running sequentially or concurrently on a single personal computer. As described herein and elsewhere, the workspaces (including any and all applications and data therein) may be securely delivered to the client systems 102.

It will be understood from the present disclosure that the client systems 102 may include integrated security while running multiple workspaces. This integrated security may be provided by an integrated security facility that provides central management and enforcement of security policies across a plurality of workspaces, applications, and so on. In embodiments, the integrated security facility may include any and all software or hardware elements that are involved in enabling authentication, validation, isolation, attestation, or the like. A variety of such elements are described herein and still others will be appreciated.

In some embodiments, the client systems 102 may include hardware that supports Intel VT or AMD-V and 64-bit addressing. In some embodiments, the client systems 102 may not support such technologies and may have 8-bit, 16-bit, 64-bit, 128-bit, 256-bit, or any other number of bits of addressing.

In some embodiments, the client systems 102 may act as so-called “fixed-function devices,” each of which runs a WEE. Each of the client systems 102 may be capable of running a user-visible workspace, a system workspace, and a bare-metal virtualization. Each of the client systems 102 may run services partitions that are hidden from a user. It should be understood that the phrase “bare-metal” may refer to software that runs directly on underlying hardware without substantial intermediating operating system software or drivers between. In some embodiments, bare-metal virtualization may rely on BIOS, microcode, programmable interrupts, or other relatively low-level software functions that are substantially built into the client systems 102.

Throughout this disclosure and elsewhere, the terms “computer” and “personal computer” may be used interchangeably to refer to one of the client systems 102.

The network 104 may include any number of networks arranged so as to provide data communications between the client systems 102 and the management system 108. As depicted, these communications may without limitation include a copy of a workspace 122, user data 124, or system disk image 128. In embodiments, the data communications may be provided according to what are known in the art as Internet Protocol v4, Internet Protocol v6, or the like. In embodiments, the network 104 may include the Internet, a local area network, a metropolitan area network, a wide are network, a personal area network, a cellular network, a storage area network, and so on. In some embodiments, the network 104 may include a shared storage system that is accessible to both the management system 108 and the client systems 102. It will be understood that a variety of embodiments of the network 104 are possible.

The management system 108 may communicate with the client systems 102 via the network 104.

The management system 108 may provide a copy of a workspace 122 to each of the client systems 102. In embodiments, each of these copies of the workspaces 122 may be communicated from the management system 108 to the client systems 102 via the network 104. Such communication may involve a file download, a data stream, or the like.

The management system 108 may receive and archive, from the client systems 102, a workspace's user data 124, a workspace's system disk image 128, and so on. In embodiments, the management system 108 may receive this user data 124 or system disk image 128 from the client systems 102 via the network 104. This may enable full or incremental backups of the workspace 122, including without limitation the user data 124 or system disk image 128 therein. Additionally or alternatively, this may enable the user data 124 or system disk image 128 in the copy of the workspace 122 to be substantially mirrored at the management system 108. As described hereinabove and elsewhere, the network 104 may include a shared storage system and so the management system 108 may be said to receive the user data 124 or system disk image 128 when the client systems 102 write to this shared storage system.

The management system 108 may enable an administrator to manage and configure the workspaces. Managing and configuring a workspace may include creating, modifying, or deleting the workspace. Without limitation, modifying the workspace may include adding, removing, or updating an aspect of the workspace, this aspect including an operating system image, an application, user data 124, a policy, or the like. In embodiments, this managing and configuring may take place via a command-line interface, via the web-based management console 120 (which is described in detail hereinafter), or the like.

In embodiments, the management system 108 may be operated by a business entity or the like that provides services to the client systems 102 on a fee-for-service basis. For example and without limitation, an operator of the management system 108 may impose a fee for communications between the client systems 102 and the management system 108. For another example and also without limitation, the operator may impose a fee for storing user data 124, for storing more than a certain amount of user data 124, for storing the system disk image 128, and so on. It will be understood that the operator may impose a variety of fees for services that are enabled by or enhanced by the management system 108. Impositions of all such fees are within the scope of the present disclosure.

The mobile computers 110 are personal computers and may include any and all forms of mobile computer. For example and without limitation, the mobile computers 110 may include laptop computers, handheld computers, palm-top computers, so-called smart phones, cell phones, and so on. It will be understood that a variety of embodiments of the mobile computers 110 are possible.

The desktop computers 112 are personal computers and may include any and all forms of desktop computer. For example and without limitation, the desktop computers may include workstations, home computers, or the like. It will be understood that a variety of embodiments of the desktop computers 112 are possible.

The computing center 114 may provide application logic and data processing capabilities to the management system 108. This may enable the management system 108 to carry out its activities, which are described hereinabove and elsewhere. In embodiments, the computing center 114 may include any number of server-class computers or the like arranged in one or more data centers. In embodiments, the computing center 114 may include any number of switches, hubs, firewalls, load balancers, or other suitable networking equipment. This networking equipment may provide communications between the components of the management system 108 and, as appropriate, may provide communications between those components and the network 104. It will be understood that a variety of embodiments of the computing center 114 are possible.

The data repository 118 may provide data storage capabilities to the management system 108. This may enable the management system 108 to store workspaces, to store aspects of workspaces (operating system images, applications, user data 124, policies, and so on), and so forth. In embodiments, the data repository 118 may include any number of hard drives, tape storage devices, solid-state storage devices, or the like, any and all of which may be arranged in an array. In some embodiments, this array may be arranged and managed according to what is known in the art as hardware or software RAID. The data repository 118 may be operatively coupled to the computing center 114. In embodiments, this operative coupling may include an Internet Protocol network path, which may traverse any and all of the networking equipment of the computing center 114. In some embodiments the data repository 118 may exist in more than one data center, or in a data center that does not entirely contain the computing center 114. In such embodiments, the data path of the operative coupling may traverse the network 104 as well. It will be understood that a variety of embodiments of the data repository 118 are possible.

In some embodiments, any and all of the data in the data repository 118 may be subject to access controls. Without limitation, these access controls may be provided via one or more forms of encryption of data in the data repository 118, network security policies that limit communications between the data repository 118 and other computers, and so on. In some embodiments, the encryption may rely upon what is known in the art as a public key infrastructure. In any case, a variety access controls will be appreciated, and all such access controls are within the scope of the present disclosure.

For example and without limitation, in embodiments a user may have an account, which is used to perform access control. The user account may be logically associated with a virtual computing profile, which may exist in the data repository 118. In embodiments, the virtual computing profile may exist at least in part as a plain text file, a binary file, an ASCII file, an XML file, a database record or entry, an Active Directory record, an LDAP record, or the like. In any case, the virtual computing profile may list a number of virtual workspaces to which the user has access.

A subscription may be created in the virtual computing profile when the user first runs a virtual workspace. This subscription may store a system disk image 128 that is logically associated with that virtual workspace. Updates to the system disk image 128 may be reflected in the subscription. When the user later accesses the virtual workspace, the subscription and the system disk image 128 may be retrieved.

In some embodiments, each and every workspace may be stored in the data repository 118. Updates to a workspace may be published in the data repository 118 as new versions of the workspace. In some embodiments, any and all versions of the workspace may be immutable. In some embodiments, the data repository 118 may employ copy-on-write disks (sometimes referred to as differencing disks) to express the differences between the versions.

The web-based management console 120 may provide a user interface through which an administrator or the like operates the computing center 114. In embodiments, the web-based management console 120 may include one or more websites, application user interfaces, or the like. In some embodiments, the web-based management console 120 may be delivered to an administrator or the like via a web browser. In any case, the web-based management console 120 may be delivered to an administrator or the like via a web page on a computer (desktop, laptop, palmtop, or otherwise), via a text message to a cell phone, via an instant message to an instant messenger, and so on. In embodiments, input to the web-based management console 120 may include mouse input, keyboard or keypad input, voice input, or the like. It will be understood that a variety of embodiments of the web-based management console 120 are possible.

Access to the web-based management console 120 may be limited by a security measure. In embodiments, the security measure may involve a username and password, a challenge and response, a physical security token (such as a dongle, security card, or the like), a biometric scan, or the like. It will be understood that a variety of embodiments of the security measures are possible.

In some embodiments, an end user (i.e., a user of one of the client systems 102) may have access to the web-based management console 120. In such embodiments the end user may create or manage a workspace for himself via the web-based management console 120.

In some embodiments, any and all of the capabilities of the web-based management console 120 may be provided by a command-line interface, a scripting interface, or the like. In such embodiments, the web-based management console 120 may or may not be present.

The copy of the workspace 122 may reflect a workspace that was created by a corporate administrator, a workspace that was created by the end user or another user, and so on. In some embodiments, the copy of the workspace 122 may co-exist and execute substantially concurrently with another copy of another workspace 122 on one of the client systems 102. It will be understood that the hypervisor of the WEE may enable such concurrency while maintaining substantially full isolation of one workspace from the other workspace.

In some embodiments, the copy of the workspace 122 may reflect a specialized workspace, the execution of which may not be visible to or accessible by the end user. A trusted third party, an operator of the management system 108, or the like may create such a specialized workspace. The specialized workspace may include a PC-monitoring application, a backup application, an anti-virus application, a root-kit detection application, or the like. In any case, execution of the specialized workspace on one of the client systems 102 may create a system management environment that can be remotely controlled and managed over the network 104 by an administrator.

At times, the copy of the workspace 122 may be packaged and encapsulated as a virtual machine that is communicated in a portable virtual machine format. One such format may include the Open Virtual Machine Format (OVF). A variety of other such formats will be appreciated. In any case, it will be understood that the copy of the workspace 122 may be packaged and encapsulated in many ways, all of which are within the scope of the present disclosure.

In some embodiments, the copy of the workspace 122 may be delivered to one of the client systems 102 via a physical medium such as a CD, DVD, external hard drive, Bluetooth device, and so on.

The copy of the workspace 122 may include a virtual hard disk image. In some embodiments, the virtual hard disk image may be built and stored in the management system 108, to be delivered to one of the client systems 102 as needed. In some embodiments, the virtual hard disk image may be built and delivered substantially on demand or as needed. In some embodiments, the virtual hard disk image may be built directly in one of the client systems 102. In some embodiments, virtual hard disk images may be individually accessible from the data repository 118 (which may be referred to herein and elsewhere as a “virtual disk repository”).

The user data 124 may include files, directories, database tables, or other data created or modified by a user. In embodiments, the user data 124 may include data that is designated as belonging to a particular user or group of users. The user data 124 may include a variety of permissions, file types, status bits, dates and times of data creation or modification, and other such metadata. A variety of such metadata will be understood.

The system disk image 128 may include files, directories, or the like that include an installation of an operating system and applications. It should be appreciated that the installation may include executables, scripts, libraries, character devices, block devices, pseudo-devices, data files, or the like. It will be understood that the contents of the system disk image 128 may vary, and that a variety of embodiments of the system disk image 128 are possible.

Communications over the network 104 may be encrypted, compressed, or otherwise encapsulated. Thus, the user data 124, the system disk image 128, and so on may be encrypted, compressed, or otherwise encapsulated for communication over the network 104.

In some embodiments, the copy of the workspace 122 does not include a so-called “personality,” which is to say that it lacks personal definitions such as a computer name, a user account identifier, a system identifier, so-called “hard variables” of an operating system, and the like. In such embodiments, one of the client systems 102 may inject the personality into the copy of the workspace 122. This personality may be customized for an end-user, for the one of the clients systems 102, and so on. In this way, embodiments of the present invention may provide customized environments for each of a relatively large number of end users and client systems 102 while maintaining a relatively small number of workspaces at the management system 108.

For example and without limitation, an administrator may create a master image (or “root disk image”) of a workspace from scratch or by cloning an existing image of workspace. Then, the administrator may apply patches to the master image, install new applications into the master image, and so on. Having completed such modifications to the master image, the administrator may publish the master image to a plurality of users. This act of publishing may pull out any temporary personalization that might have been put into the master image, leaving a so-called “clean” master image (that is, one without personalization). The clean master image may be communicated to the client systems 102 as the copy of the workspace 122. After the copy of the workspace 122 arrives at one of the client systems 102, that one of the client systems 102 may inject a personality into the copy of the workspace 122.

More generally, a master image may be created, personalized, depersonalized, re-personalized. The creation, personalization, depersonalization, and re-personalization of the master image (or a copy 122 thereof) may take place at the management system 108, at the client systems 102, under the control of an administrator, under the control of a user, and so on.

In some embodiments, an end user may access a particular copy of the workspace 122 from any of a number of the client systems 102. In such embodiments, the end user may enter login information or other credentials into one of the client systems 102. Upon verification of this information or these credentials, this one of the client systems 102 may retrieve the particular copy of the workspace 122 from the management system 108 and then run it. In embodiments, this copy of the workspace 122 may be a copy of the newest version of the workspace 122.

When a user is running an out-of-date version of the workspace 122, the WEE may inform the user that a newer version is available. This may encourage the user to reboot the workspace's virtual machine, at which time the WEE may run the newer version of the workspace in place of the out-of-date version. In some embodiments, from the user's perspective, this upgrading from the out-of-date version to the newer version may require no work beyond rebooting the workspace's virtual machine. In any case, the WEE may download the newer version from the management system 108.

Similarly, the WEE may update itself by downloading a new version of its own privileged virtual workspace from the management system 108. In some embodiments, the personal computer on which the WEE is running may need to reboot in order to bring online the privileged virtual workspace.

The management system 108 may build on demand any and all aspects of the copy of the workspace 122. A copy of the workspace 122 that is built in this manner may be tailored for an end user and in a manner that is suitable for running on the particular one of the clients systems 102 that the end user is utilizing. For example and without limitation, when the end user accesses the copy of the workspace 122 on an Apple PowerBook G4 then the copy of the workspace 122 may be built to include a PowerPC-native version of Apple's OS X operating system. However, when the same end user access the copy of the workspace 122 on a MacBook Pro then the copy of the workspace 122 may be built to include an Intel-native version of Apple's OS X operating system. In both cases the copy of the workspace 122 may include the substantially the same user data 124. Moreover, in both cases the copy of the workspace 122 may include substantially the same applications, especially if the applications are universal-type applications that can run on PowerPC or Intel architectures; if an emulator is included in the operating system or in an application, the emulator allowing applications for one architecture to be run on another architecture; and so on. Alternatively, substitute or architecture-specific versions of the applications may be included in the copy of the workspace 122. A variety of other such examples will be appreciated.

In some embodiments a “locked-down” copy of the workspace 122 may be configured to disallow or not support network access. For example and without limitation, the copy of the workspace 122 may not include requisite network drivers for accessing the network 104. For another example and also without limitation, the copy of the workspace 122 may include a firewall or other application that is pre-configured to prevent network access. It should be appreciated that the WEE and other copies of other workspaces 122, all of which may be running substantially concurrently with the locked-down copy of the workspace 122, may be able to access the network 104 even though the locked-down copy cannot.

The WEE may include or may utilize a disposal facility. As its name suggests, the disposal facility may dispose all or part of a workspace. Disposing of all or part of a workspace may include deleting some or all of a workspace's data or otherwise rendering such data substantially unusable. In some embodiments, the disposal facility may include a multi-pass disk deletion utility or the like. In some embodiments, the disposal facility may delete one or more keys that are necessary to access an aspect of the workspace. In some embodiments, the disposal facility may include a hardware register or component that is reset or otherwise altered so as to prevent all or part of a workspace from being authenticated, attested, unsealed, decrypted, or otherwise made ready for use. In view of the present disclosure, it will be appreciated that a variety of embodiments of the disposal facility are possible.

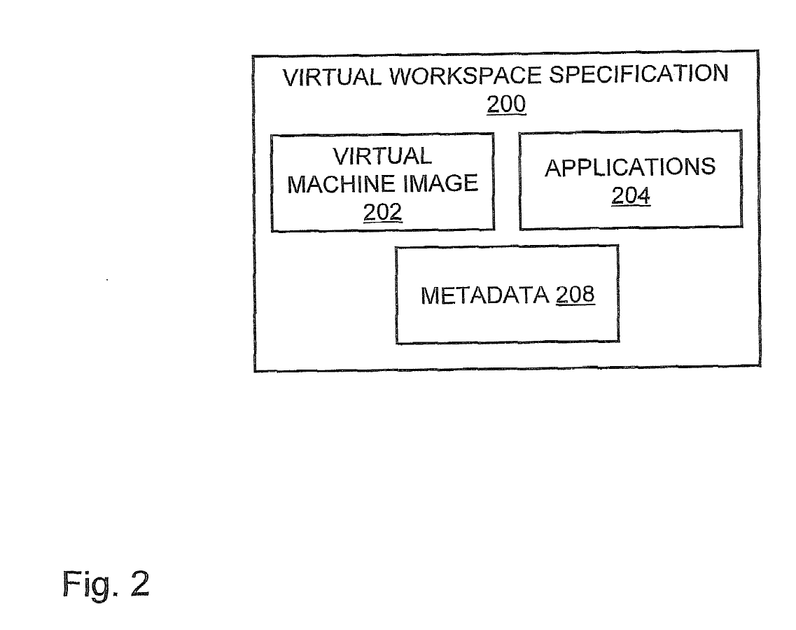

FIG. 2 depicts a virtual workspace specification. The virtual workspace specification 200 includes a virtual machine image 202, applications 204, and metadata 208.

The virtual workspace specification 200 may embody the copy of the virtual workspace 122. In embodiments, the virtual workspace specification 200 may be provided as one or more data files, each of which may be compressed, encrypted, and so on.

In embodiments, the virtual machine image 202 may include at least one virtual disk image. A virtual disk image of the virtual machine image 202 may include a functional operating system and various applications. This virtual disk image may be referred to as a “system virtual disk.” Another virtual disk image of the virtual machine image 202 may include substantially persistent user data 124, such as files, settings, and the like. This virtual disk image may be referred to as a “user virtual disk.” Yet another virtual disk image of the virtual machine image 202 may include substantially transient user data 124. This virtual disk image may be referred to as a “transient virtual disk.” The virtual machine image 202 may also include a so-called “memory image” that holds a suspended virtual machine's state.

Any and all aspects of the virtual machine image 202 may be accessed and updated by the WEE. For example and without limitation, the WEE may write to the memory image as a virtual machine is entering a suspended state; read from the memory image as a virtual machine is exiting a suspended state; read or write from a copy of a subscription within the virtual machine image 202; and so on. Also for example and without limitation, prior to running a virtual workspace, the WEE may create a copy-on-write copy of the virtual machine image 202 or aspects thereof. In yet another example, the WEE may instantiate a transient disk when a virtual workspace requires but does not already have one. Still other such examples will be appreciated.

The applications 204 may include any and all applications that are part of a virtual workspace according to the virtual workspace specification 200. In embodiments, the applications 204 may be encoded as one or more virtual disk images, or as part of one or more virtual disk images. The applications 204 may include a set of virtualized applications that reside outside of the virtual machine image 202 and are encapsulated in their own individual containers. In some embodiments, the WEE may dynamically or statically load such applications 204 into a virtual machine.

Generally, a virtualized application may be an application that is run on top of an operating-system virtualization layer. In some embodiments, the application may be adapted to run on top of an operating system, but not specially adapted to run on top of an operating-system virtualization later. In some embodiments, the application may be specially adapted to run on top of an operating-system virtualization layer. For example and without limitation, the application may be compiled to run on the operating-system virtualization layer, may include a dynamically linked library that allows the application to run on said layer, and so on.

The operating-system virtualization layer may provide to the virtual application any and all services of an operating system. For example and without limitation, this layer may provide the virtual application with access to operating system services that relate to processes, threads, memory, secondary storage, peripherals, graphics, interprocess communications, network communications, and so on. Still other operating system services will be appreciated.

The metadata 208 may include any and all of the system data or user data 124 described hereinabove and elsewhere. In embodiments, the metadata 208 may include policies or the like so on. In some embodiments the metadata 208 may be encoded in XML, although many suitable data formats will be appreciated.

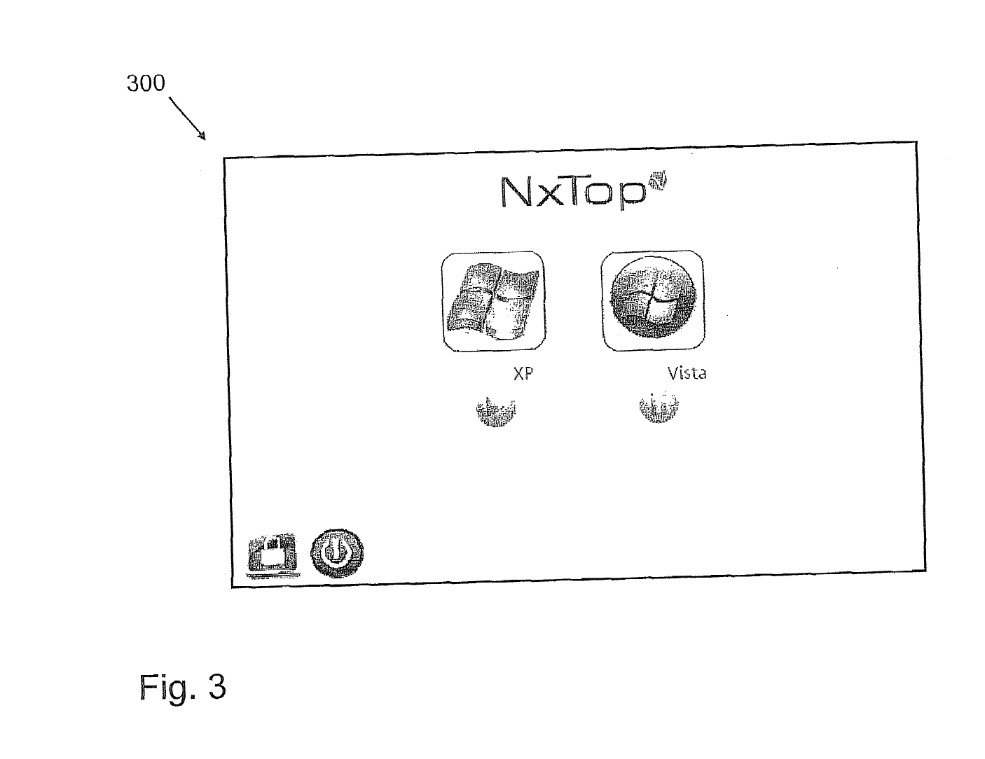

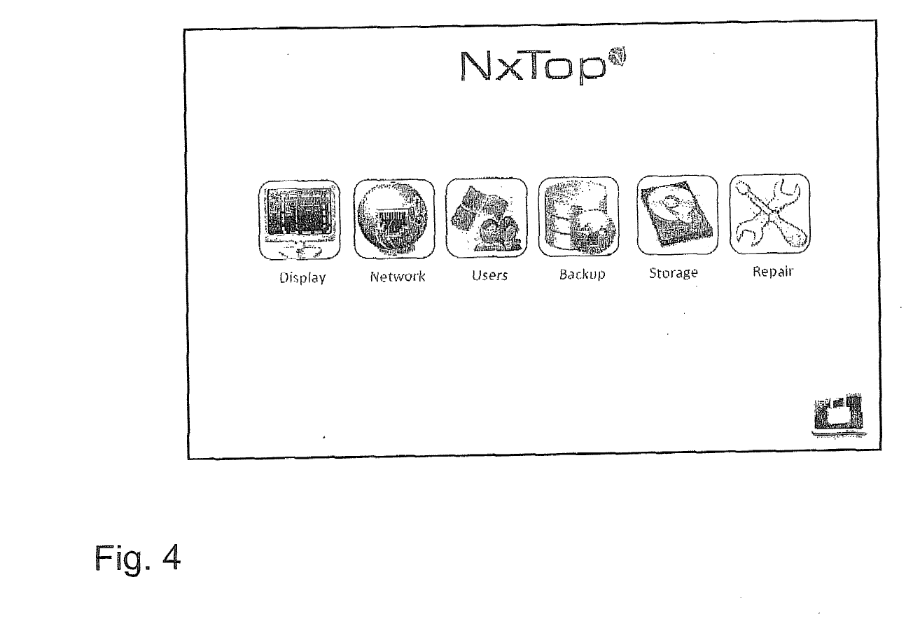

FIG. 3 and FIG. 4 depict a user interface of a WEE. These figures include icons, many of which have labels, and all of which are discussed in detail hereinafter. It should be appreciated that the labels in FIG. 3 and FIG. 4 are intended to be illustrative and not limiting.

Before going into detail, however, it should be understood that FIG. 3 and FIG. 4 are provided for the purpose of illustration and not limitation. In particular, it should be appreciated that embodiments of the user interface of the WEE may include any number of icons that are presented in any arrangement. Such an arrangement may include a hierarchy of icons, multiple pages of icons, and so on. Generally, the icons may represent users, groups, workspaces, a hierarchy of any and all of the foregoing, or the like. In some embodiments, the user interface of the WEE may include an aspect that is available to an administrator, an aspect that is available to an end user, and so on. In some embodiments, the administrator may be a remote (or centrally located) administrator and the user interface may be made available to the administrator, by the WEE, and via the network 104.

In all, the WEE's user interface and the like may provide a user interface that allows the WEE to authenticate a user and support a variety of user interactions. Without limitation, the user interactions may include starting a workspace, stopping a workspace; suspending a workspace to a memory image; resetting a workspace to destroy transient disks and memory images while keeping a user's disk; deleting a workspace to remove the user's subscription and user's virtual disk; undoing a change to a virtual disk, thus providing a previous snapshot (or version) of the virtual disk; and so on.

The user interface 300 of the WEE may be employed to authenticate a user and allow the user to perform a number of operations on a virtual workspace. For example and without limitation, after a personal computer boots up the WEE may present a login window into which a user enters a user name and password. Upon verification of the user name and password, the WEE may present the user with a list of virtual workspaces to which the user has access (as in FIG. 3). Once the user chooses one of the virtual workspaces from the list, the WEE may present a number of operations relating to it. When the user chooses one of these operations, the WEE may execute it. Additionally or alternatively, the user interface 300 of the WEE may present a number of the WEE's management functions (as in FIG. 4).

Referring now to FIG. 3, two relatively large icons each represent a distinct virtual workspace. From left to right, these icons are labeled “DSL,” and “XP-SP2.” When a user selects one of these relatively large icons, the corresponding virtual workspace may be activated or brought into the foreground.

Toward the lower left of the user interface there are two, relatively small icons. From left to right, these icons depict a padlock (“the padlock icon”) and a power on/off symbol (“the power icon”).

In some embodiments, selecting the padlock icon in order to lock or unlock the user interface.

In some embodiments, selecting the padlock icon may lock down any and all virtual disks, creating new copy-on-write versions of the virtual disks prior to booting a virtual workspace and then discarding the virtual disks on shutdown of the virtual workspace. This may, for example and without limitation, prevent a user from installing software that persists between instantiations of the virtual workspace.

In some embodiments, selecting the power icon in order to power down, put to sleep, or suspend the personal computer on which the WEE is running. It will be understood that a variety of other such icons are possible.

Toward the lower right of the user interface in FIG. 3 is a trademark. In some embodiments, selecting the trademark may bring up system information that relates to the personal computer on which the WEE is running. Such system information may without limitation include the WEE's software version; high-level hardware statistics such as total RAM, CPU type and speed, and the like; and so on. Alternatively, selecting the trademark may bring up system information that relates to the virtual computer in which the user's virtual workspace will run. Such system information may without limitation include the virtual computer's total RAM, the virtual computer's CPU type (emulated or actual) and effective speed, the virtual computer's BIOS version, and so on. The system information may include an amount of data to be backed up, a wireless networking configuration, a configuration parameter, a status indicator, and so on.

Starting a virtual workspace may boot the latest version of the virtual workspace or resume the virtual workspace from a suspended state. Stopping a virtual workspace may shut down the virtual workspace. Suspending the virtual workspace may suspend the virtual workspace to a memory image. Resetting the virtual workspace may destroy all transient images and the memory image of the virtual workspace, while keeping all user virtual disks of the virtual workspace. Deleting the virtual workspace may destroy the user's subscription to the virtual workspace, including the user virtual disks of the virtual workspace. Undoing the virtual workspace may allow a user to go back to a previous snapshot of his user virtual disk. Publishing the virtual workspace may allow an administrator to create a new version of the virtual workspace that includes a current system virtual disk. Backing up the virtual workspace may include performing a complete backup of the user virtual disk.

In cases where insufficient network bandwidth between a personal computer and the management system 108 prevents immediate backup of the virtual workspace, copy-on-write snapshots of the virtual workspace may accumulate on the personal computer for later transfer to the management system 108. In some embodiments, the WEE may respond to excessive accumulation of such snapshots by reducing the frequency of snapshots, collapsing multiple snapshots together, and so on.

Upon starting a virtual workspace on a personal computer, the virtual workspace may, in some embodiments, “own” a keyboard, mouse, and screen of the personal computer. By pressing a hot key combination, the user may return to the user interface 300 that hast the list of virtual workspaces. In embodiments, this hot key combination may be Ctrl-Alt-Tab, Ctrl-̂, Ctrl-v, or the like.

Referring now to FIG. 4, a number of relatively large icons each represent a management function. From left to right, these icons are labeled “Display,” “Network,” “Users,” “Backup,” “Storage,” and “Repair.” In all, these management functions may enable a user to configure a display, configure or monitor a network, configure one or more users or user accounts, monitor or initiate a backup of virtual workspace, monitor usage of local or remote storage, repair virtual workspace or an aspect thereof, and so on.

Referring now to the client systems 102 of FIG. 1, embodiments of the client systems 102 may include TPMs and may support a process known as “measured and verified launch” or “trusted boot.” Generally, as one of the client systems 102 undergoes a trusted boot the client system's 102 TPM measures and reports the running state of hardware and software. In some embodiments, the TPM may have a plurality of so-called Platform Configuration Registers (PCRs) embedded with it. These PCRs, the contents of which may be under the control of the TPM, may contain the running state. For example and without limitation, the running state may be encoded as a number of 160-bit hash values, each of which may be stored in one of the PCRs. In some embodiments, the trusted boot may be implemented using an open source project widely known tboot, or an equivalent thereof. It should be understood that the trusted boot result in the instantiation and operating of a plurality of workspaces.

In embodiments, when one of the client systems 102 (“client computer”) is initially booted or reset, its TPM's PCRs are set to zero. Then, a Core Root of Trust Measurement (CRTM) is taken of the BIOS of the client computer. This measurement determines initial values for the PCRs. The BIOS (regardless of its integrity) may then measure a bootloader or other hardware and software on the client computer. The results of these measurements may be used to further extend the values of the PCRs that were initially established by the CRTM. In some embodiments, what is known in the art as a SHA1 cryptographic hash may be employed to extend the values in the PCRS. For example and without limitation, the TPM may append the results of the measurements may be concatenated to the PCRs values to produce new source values, each of which is then hashed and stored back into the PCRS. As subsequent stages of booting occur (e.g., first bootloader, then operating system, and so on) additional measurements (e.g. of applications, of configuration files, and so on) may be used to further extend the values in the PCRs. In this way, the PCRs may contain values that reflect a current running configuration of the client computer at each stage boot stage.

In order to ensure that booting process to be a trusted booting process, the TPM may be used to seal data into a given platform configuration. For example and without limitation, the TPM may encrypt an arbitrarily long data set along with configuration information (i.e., PCR values) so that the TPM will only unseal (i.e., decrypt and disclose) the data when the TPM's PCRs are in the specified configuration. The sealed data may be stored anywhere within the platform 100 (and perhaps at times even outside of the platform 100). Since the sealed data is encrypted, it need not be veiled within the TPM.

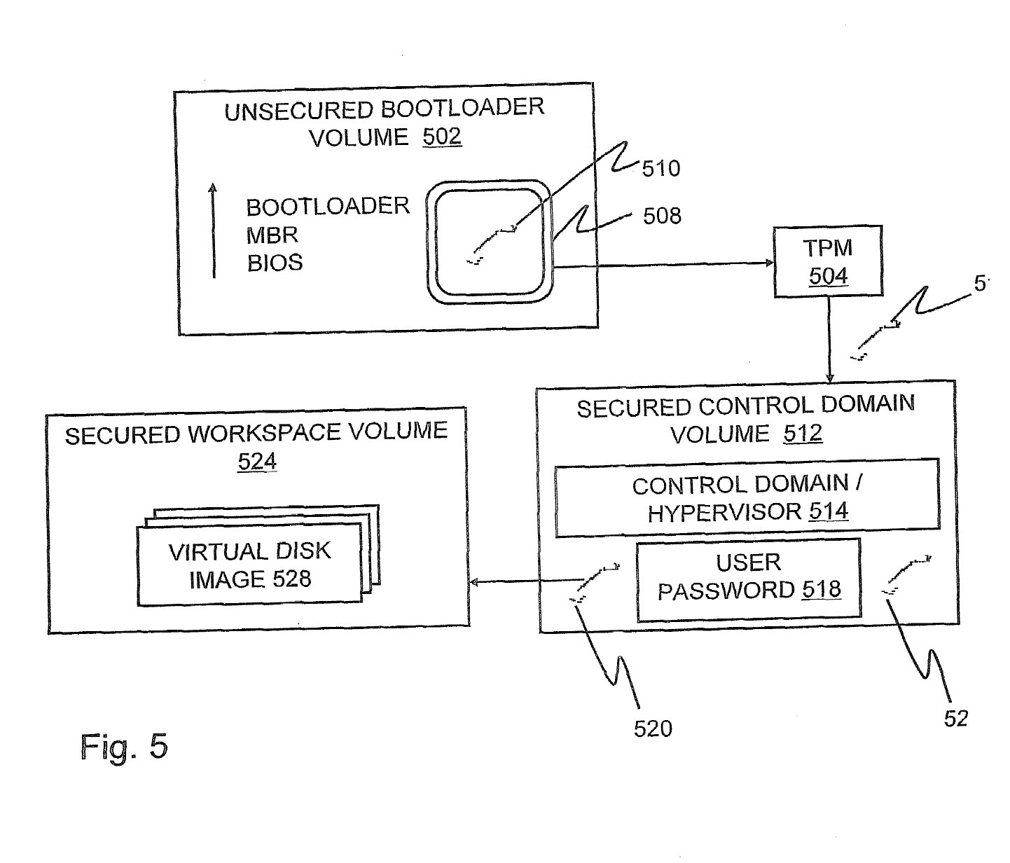

FIG. 5 depicts data volumes and a trusted boot sequence. The data volumes include an unsecured bootloader volume 502, a secured control domain volume 512, and a secured workspace volume 524. The unsecured bootloader volume 502 includes a key 510 to the secured control domain volume 512, BIOS, a Master Boot Record (MBR), and a bootloader. The key 510 is under cryptographic seal 508. The secure control domain volume 512 includes a control domain or hypervisor 514, a user password 518, a key 520 to the secured workspace volume 524, and a key 522 that is used to authenticate the management system 108. The secured workspace volume 524 includes a plurality of virtual disk images 528.

The trusted boot sequence utilizes the TPM 504 to break the seal 508 and provide the key 510 that decrypts the secured control domain volume 512. First, the data volumes are loaded into client computer. Then, various components of the unsecured bootloader volume 502 are successively invoked. These are, in order: the BIOS, the MBR, and the bootloader.

When executed, the bootloader transfers the key 510 under cryptographic seal 508 to the TPM 504, which breaks the cryptographic seal 508 to reveal, in unencrypted form, the key 510. Then, the key 510 is used to decrypt the secured control domain volume 512. Once this volume 512 is decrypted, the bootloader executed the control domain or hypervisor 514.

The control domain or hypervisor 514 then proceeds decrypt the secured workspace volume 524 using the key 520. Once that is complete, the control domain or hypervisor 514 mounts the virtual disk images 528 and boots virtual computer, in a guest domain, from a bootable one of the virtual disk images 528.

Throughout this disclosure and elsewhere the phrases “virtual machine disk image” and “virtual hard disk image” may refer to a virtual disk image 528. In embodiments the virtual disk image 528 may include a disk image. Embodiments of a virtual disk image 528 may be encoded according to Microsoft's Virtual Hard Disk Image Format Specification (i.e., “in VHD format”) or any other specification for encoding virtual hard disks. It will be understood that a variety of embodiments of the virtual disk image are possible.

In embodiments, the TPM's 504 trusted boot capability may be employed to guarantee that workspaces operate in a secure, uncompromised environment. The hypervisor 514 and secrets (e.g., key 520) that it needs to run workspaces may be secured with an encrypted volume (e.g. 512), the key 508 for which may is bound both to the client computer's TPM 504 and to the boot configuration (PCRs) of a trusted bootloader (i.e., the bootloader in the unsecured bootloader volume 502). Thus, only when the personal computer successfully boots through the trusted bootloader will the TPM's 504 PCRs be in the configuration necessary for the TPM 504 to disclose the control domain's workspace encryption key (i.e., to break the cryptographic seal 508, revealing the key 510).

In some embodiments, the key 510 may be stored on the management system 108. If the client computer's TPM 504 were to be reset, the key 510 may be re-encrypted by the management system 108 using the then current values in the TPM's 504 PCRs, which may be communicated to the management system 108. In order to authenticate communications with the management system 108, the key 522 may be employed. In some embodiments, the key 522 may include a site certificate or the like.

In some embodiments, a client computer may be shipped with its TPM 504 in a disabled state. Before a trusted software installation can be performed, the TPM 504 may need to be enabled. In some embodiments, the TPM 504 can be only be enabled from the client computer's BIOS, thus ensuring the user that enables the TPM 504 has physical possession of the client computer.

Once the TPM 504 is enabled then ownership of the TPM 504 may be established via software. In embodiments this software may provide a management function of the WEE with which the ownership is established. Establishing ownership of the TPM 504 may involve the specification of two passwords, an owner password and what is know in the art as a Storage Root Key (SRK) password.

In embodiments, knowledge of the owner password permits a user to perform certain administrator operations on the TPM 504 (for example and without limitation, migration of keys).

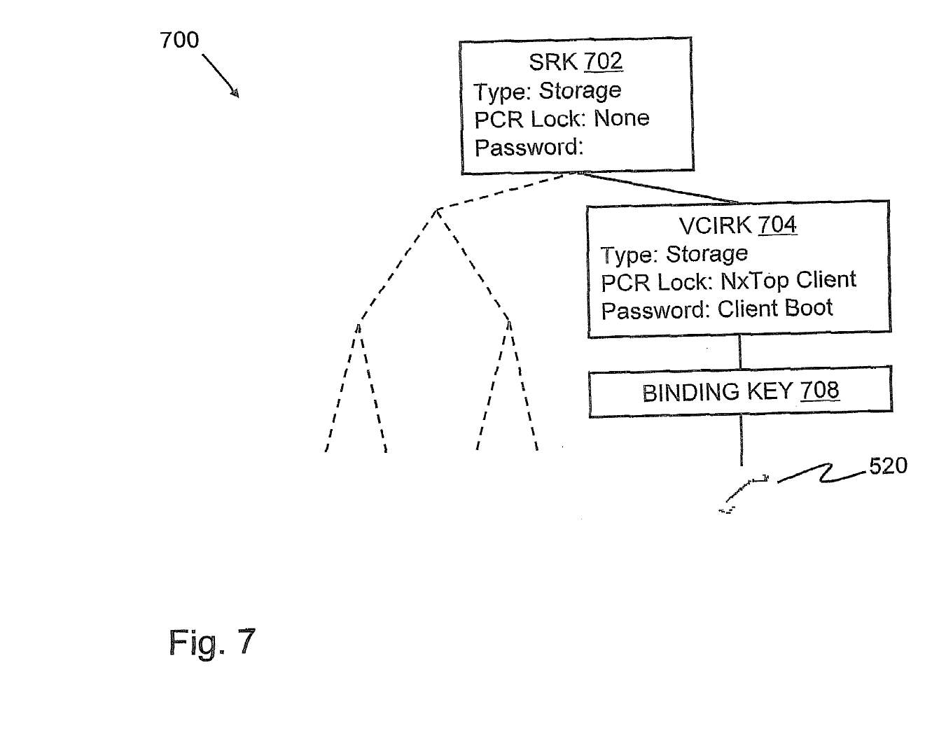

A hierarchy of keys (described in greater detail hereinafter with reference to FIG. 7) may include the SRK password at its root. Thus, the SRK password may be needed in order to access any TPM-bound keys (including without limitation the keys 510, 522, 522, and so on). In some embodiments, the SRK password may be set to a well-known value and subordinate keys (such as and without limitation the key 510 to the secured control domain volume 512) may be protected by binding them PCR values or other authentication data. In some embodiments the TPM 504 may randomly generate the SRK at the time ownership of the TPM 504 is taken. In some embodiments the TPM 504 may regenerate the SRK whenever a new owner is established. In some embodiments, the SRK may never leave the physical TPM 504.

In some embodiments, a trusted user may install the unsecured bootloader volume 502 in a client computer. The trusted computer may take physical possession of the client computer, enable the TPM 504, and take ownership of the TPM 504. The user may then install a trusted copy of the unsecured bootloader volume 502 into the client computer. Next, the trusted user may boot the client computer, thereby establishing trusted PCR values for the client computer. These are the PCR values may then be used to apply the cryptographic seal 508 to the key 510 that is used to decrypt the secured control domain volume 512. The trusted user may then, using a management function of the WEE, securely connect to the management system 108, log in to the management system 108, and register the client computer with the management system 108.

Registration credentials may be exchanged during this registration process. The registration credentials may be stored in the secured domain control volume 512. In embodiments, the registration credentials may include a globally unique identifier for the client computer and the key 522 that is needed to authenticate communications with the management system 108). In some embodiments, the registration credentials may include the TPM's 504 public endorsement key (PUBEK) and BIOS UUID as unique identifiers of the client computer.

As an alternative to a trusted user installing the unsecured bootloader volume 502 in the client computer, an attestation feature of the TPM 504 may be used by the management system 108 in order to remotely verify that a secure installation was correctly performed on a client computer. Attestation may permit a TPM 504 to certify its current configuration (i.e., PCR values) to another entity by digitally signing the TPM's 504 PCT values along with a nonce value provided by the management system 108. Here, the management system 108 may only need to verify the signature on the TPM's 504 response.

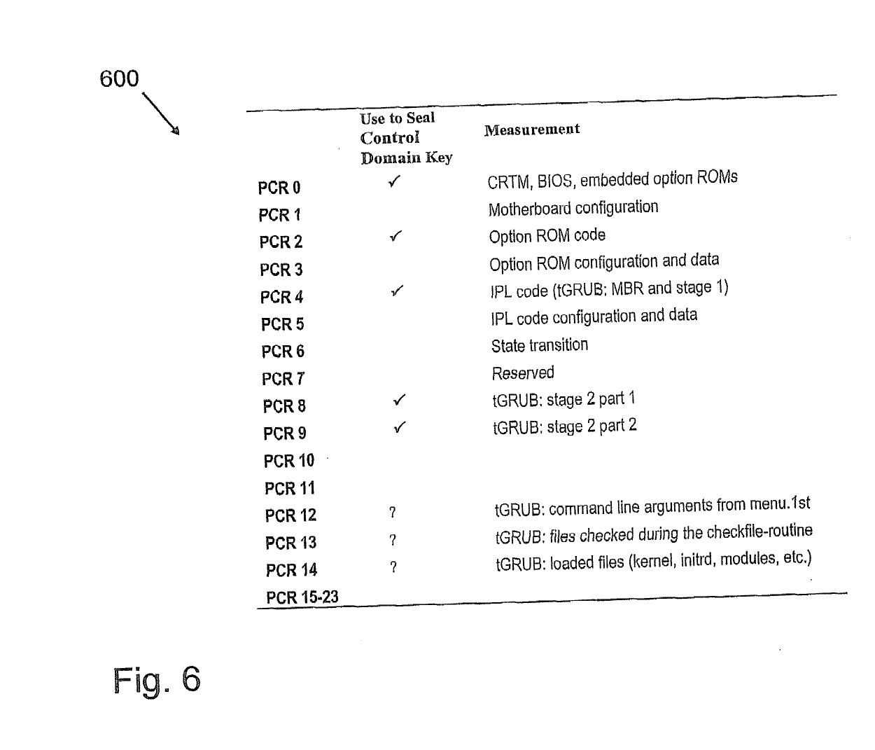

FIG. 6 depicts a set of PCRs. This set 600 of PCRs, provided for the purpose of illustration and not limitation, shows a conventional assignment of measurements to PCRs up through the execution of a bootloader. The figure depicts a subset of the PCRs, indicated by a check mark, which may be selected for use in sealing the control domain key. This subset is selected so that select changes to the client computer (e.g., the addition or removal of memory) will not affect the PCRs used in sealing the control domain volume key. In some embodiments, after the control domain volume key is retrieved, at least one of the PCRs in the subset may be extended by the bootloader to prevent further disclosure of the key by the TPM 504.

In embodiments wherein no TPM 504 exists (or wherein a TPM exists but is disabled) the control domain volume key may be stored in an alternate manner. For example and without limitation, this key may be stored on a removable memory stick, or it may be stored on the boot volume and encrypted using a user password, biometric data set, or the like.

FIG. 7 depicts a key hierarchy. The key hierarchy 700 includes an SRK 702, an intermediate root key labeled VCIRK 704, a binding key 708, and the key 520 that is used to decrypt the secured control domain volume 512. The VCIRK 704 may allow the client computer to introduce additional authentication factors on its key sub-tree without affecting the SRK 702. The binding key 708 may wrap migratable keys such as disk encryption keys.

In embodiments, the TPM 504 may distinguish between migratable and non-migratable keys. Migratable key may be exported from one TPM 504 and imported into another. Non-migratable keys may be bound to a specific TPM 504 (i.e., encrypted by its SRK 702) and thus may not be exposed outside of that TPM. In some embodiments, the control domain or hypervisor 514 may take advantage of non-migratable keys whenever possible in order to reduce the risk of inadvertent disclosure. For example and without limitation, the management server authentication key 522 may be made non-migratable so that only one client computer is capable of generating the signature necessary to authenticate this client computer to the management system 108. As depicted, the key 520 that is used to decrypt the secured workspace volume 524 and its virtual disk images 528 may be migratable. This may allow the management server 108 to cache the key 510.

In embodiments, authorization to load and use a TPM 504 key may be protected using any of a number of independent fractures, including the following: (a) authorization to load and use its parent key; (b) specification of a secret (also known as authData), which may be a hash value derived from a password or some other factor (e.g., biometric or other input); and (c) specific configuration of one or more PCR values (i.e., the key may be locked into a specific boot configuration).

In embodiments, the client systems 102 may take advantage of at least factor (a) and (c). In some embodiments a client boot password may be employed, allowing factor (b) to be applied to the VCIRK 704.

Authentication between the client systems 102 and the management system 108 may take any of several forms. In some embodiments the management server 108 authenticates itself to the client through SSL using a server certificate. That certificate may be a commercially issued (e.g., by Verisign, Inc. or the like), but could be privately generated when the certificate's root is an SRK 702.

Authentication of one of the client systems 102 to the management system 108 may involve digest authentication in the case of a user-initiated action. In some embodiments of digest authentication, this one of the client systems 102 may establish an authenticated HTTP session with the management system 108 using digest authentication. Alternatively, it should be appreciate that an NTLM authentication could be used when the management server 108 includes what is known in the art as an Active Directory deployment. Protocols that provide digest authentication will be appreciated.

Authentication of one of the client systems 102 to the management system 108 may involve management end-point authentication. This authentication may involve one of the client systems 102 establishing an authenticated HTTP session with the management server 108 using public key encryption or the like. Similar to digest authentication, this one of the client systems 102 may attempt to initiate an action at the management server 108. This initial attempt may be rejected. In embodiments, such a rejection may include a 401-status message. Perhaps unlike digest authentication, the aforementioned client may transmit a response containing a header to the management server 108, the header that indicating the client's UUID or the like. In addition, the header may include a digital signature of the server's challenge key (alone with other data) using a private signing key of the client. In some embodiments, the client's TPM 504 may have generated this signing key. For example and without limitation, the following pseudocode shows how the digital signature may be generated:

Response=Sign(SHA1(server−challenge, uuid, client−nonce))

Here, Sign may be a signature function; SHA1 may be a SHA1 hash function; server-challenge may be a challenge that the management system 108 includes in the rejection; uuid may be the client's UUID; and client-nonce may be a one-time token that the management system 108 includes in the rejection. It will be understood that a variety of embodiments of the response are possible.

Having received the response, the management server 108 may use a public key (such as may be generated during the client's initial registration) to verify the authenticity of the signature. When the signature is so verified, the management server 108 may carry out the requested action, and return a new authenticated session identifier to that one of the client systems 102 that made the request.

In some embodiments, the management system 108 may include a PKI key management system. In such cases, authentication of the client systems 102 to the management system 108 may involve SSL with client certificates. Also in such cases, an administrator may enable, disable, and renew cryptographic keys. It will be understood that a variety of embodiments that authenticate the client systems 102 to the management systems 108 are possible.

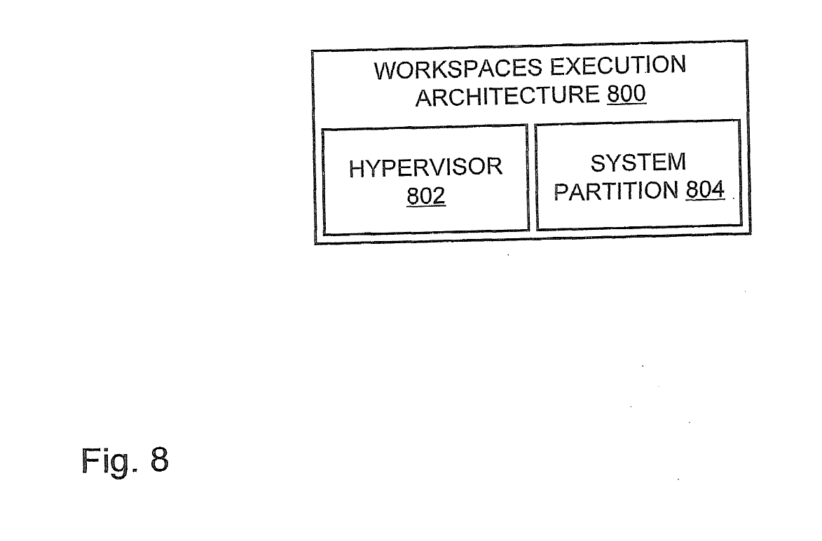

FIG. 8 depicts a Workspaces Execution Engine (WEE) architecture. The WEE architecture 800 may include a hypervisor 802 and system partition 804 containing a privileged virtual machine that has access to physical hardware and also acts as a control domain. In some embodiments, this access may be exclusive such that no other virtual machines have access to the physical hardware.

A WEE may include any and all elements of the workspace execution architecture 800. Embodiments of the WEE may be capable of running multiple virtual machines concurrently. The WEE may provide a variety of kinds of virtualization such as and without limitation the following kinds: hardware virtualization that abstracts hardware from an executing operating systems and applications; operating system virtualization that contains and isolates services for a guest operating system; application virtualization that enables an application to run virtualized on a guest operating system; and user-data virtualization. A variety of embodiments of such virtualization are described herein, and still other embodiments will be appreciated. All such embodiments are within the scope of the present disclosure.

As described hereinabove and elsewhere, embodiments may include at least two types of virtual workspaces. One type may be “user-visible” workspace while the other may be a “system services” or “control domain” workspace.

Instances of the WEE may execute a set of virtual machines. These virtual machines may have access to a user interface of the personal computer on which the instance of the WEE is operating. Each of the user-visible workspaces may run a user accessible operating system. The virtual machines in the user-visible workspaces may have access to at least one of the personal computer's peripherals or ports, such as and without limitation a USB port, a screen, a keyboard, a mouse, and so on. In embodiments, the virtual machines may reuse native, virtualizes, or paravirtualized drivers for these peripherals or ports. Some of the personal computer's devices—such as and without limitation its network interface card (NIC), disk, graphics display components, keyboard, and so on—may be fully virtualized or emulated by a device manager emulator of the WEE. In some embodiments, any and all of these devices may be accessed via a paravirtualized driver model.

The control domain workspace (or a plurality thereof) may execute substantially concurrently with the user-visible workspaces. The control domain workspaces may provide various system level services to manage and maintain user-visible workspaces running on the personal computer. These services may range from user-disks backup, to anti-virus detection, to root-kit detection and so on. It will be understood that a variety of such services are possible.

Within the WEE may exist a particular virtual machine (a “ServiceOS” or “control domain”) that executes physical drivers, runs hardware emulation software, provides virtual workspace device level management, supports security attestation of software stacks, exposes a virtual device to a user-visible virtual machine, downloads a virtual disk image 528 stored in a secured workspace volume 524 from the management system 108, runs or mounts said virtual disk image 528, and so on.

In embodiments, the virtual device may without limitation include a virtual NIC, a virtual graphics component, a virtual disk, a virtual keyboard, a virtual mouse, and so on.

In some embodiments, the hardware emulation software may include a so-called hardware independence layer, which allows a virtual disk image 528 that is tailored for a first machine architecture to run on a personal computer having a second machine architecture. For example and without limitation, machine architectures may include x86, PowerPC, and so on. It will be understood that a variety of machine architectures are possible. Similarly, it will be understood that a variety of embodiments of the hardware independence layer are possible.

The control domain may have access to the personal computer's physical devices such as network devices, disk devices, sound devices, graphics devices, and so on. It will be understood that the control domain may provide virtual versions of these devices to the user-visible workspaces.

The control domain may be capable of downloading virtual workspace images from the management system 108. The control domain may run virtual workspaces as isolated virtual machines that execute end-user visible operating systems. The control domain may maintain a more or less continuous backup of user state or system changes that are stored locally or to the data repository 118.

In embodiments, the WEE may use the TPM 504 to attest to virtual workspace image security. In light of the present disclosure, it should now be understood that the WEE may use PKI to decrypt virtual workspaces that will execute on a personal computer.

In some embodiments, the WEE may provide power management of the virtual environment and the underlying personal computer. The power management may include virtual and real aspects. The virtual activity may be limited to a virtual machine and have no affect on real power. The virtual activity may be controlled a user-visible operating system and may affect the virtual machine on which that operating system is running. For example and without limitation, virtual sleep may put a particular virtual machine into a sleep state, while other virtual machines may continue to operate. Conversely, a real power management activity may operate on physical hardware, and may cause that physical hardware to sleep, hibernate, power on, power off, or the like. In some embodiments, real sleep or standby may be executed only when all virtual machines are in sleep or standby. The WEE may reference a physical CPU's utilization in order to determine the P-state of virtual CPUs. In some embodiments, the WEE may both reference the physical CPU's utilization and the virtual system states in order to determine whether particular physical power management functions are appropriate.

For example and without limitation, the WEE may enable user-visible operating systems to put to sleep (or to hibernate) the virtual machines on which they are running. When all user-visible operating systems are asleep or in hibernation, the WEE may put the underlying personal computer to sleep or into hibernation. For another example and also without limitation, in the WEE may provide a signal (e.g., a low battery signal or some such) to the user-visible operating systems that induces the operating systems to sleep. In another example, the WEE may signal the virtual machines on which the operating systems are operating to suspend. A variety of other such examples will be understood.

In some embodiments, users may identify themselves to the WEE and provide credentials (electronic, biological, or the like) that can be used by the WEE to access the user's workspace. For example and without limitation, as part of logging in a user may enter his WEE username and password. The WEE may then use the username and password to authenticate the user to the management system 108 that stores the user's virtual workspace. Alternatively, the WEE may authenticate the user based upon local data. In any case, authenticating the user may result in the WEE receiving a PKI key pair. In some embodiments, the WEE may receive the key pair from the management system 108. In some embodiments, “receiving” the PKI pair may include using the password to decrypt a private key of the PKI pair to which the WEE already has access, thus providing the WEE with an unencrypted public/private PKI pair.

Access to storage of the management system 108 may be secured. In some embodiments, the HTTPS protocol may secure this access. Access to the storage may also support demand paging or streaming of virtual workspaces from the management system 108 to the client systems 102. In some embodiments, when a particular storage block is unavailable (e.g., due to a network time out, a network failure, or the like) the WEE may cache the block and suspend execution of the affected operating system. When the block becomes available (e.g., due to recovery of a failed network connection, or the like) the WEE may resume execution of that operating system.

Access to the storage of the management system 108 may be direct. In some embodiments, this direct access may involve an application of iSCSI, file sharing, or the like. It will be understood that a variety of embodiments that provide direct access to the storage of the management system 108 are possible.

Embodiments of the WEE may include at least two caches. One cache may be adapted for caching relatively small objects and the other may be adapted to cache copy-on-write disk blocks and the like. Small objects such as virtual machine meta-data, virtualized applications, virtual workspaces meta-data, or the like may be replicated in their entirety within the cache for small objects. Regarding the cache for copy-on-write disk blocks, snapshots of user data may be stored locally in their entirety, before being uploaded to the management system 108 for backup.

The cache for copy-on-write disk blocks may be organized to cache immutable version of disks from repositories. In some embodiments, the WEE may run a pre-fetching process to fetch virtual workspace blocks in the background. This process may check for updates to a virtual workspace that a user uses, and may populate the cache with blocks from virtual workspace when updates are available. In some embodiments, pre-fetching a complete version of a virtual workspace may support disconnected operation in which one of the client systems 102 cannot communicate with the management system 108.

It should be appreciated that storing or backing up elements of the secured workspace volume 524 to the management system 108 may provide relatively high availability of a user's workspace because the stored or backed-up elements may be downloaded to a second one of the client systems 102 in the event that a first one of the client systems 102 fails.

In some embodiments, the WEE may provide a remote-desktop access or the like to any and all of the workspaces running on a personal computer. In such embodiments, a remote client or the like may communicate with the WEE via the network 104 to provide a remote desktop user interface at the remote client. It will be understood that a variety of embodiments of the remote-desktop access and the remote desktop user interface are possible.

In some embodiments, the WEE may run on a network server that provides remote-desktop access or the any and all of the workspaces running on the network server. In such embodiments, the WEE or the workspaces may be said to be “running in the cloud.” For example and without limitation, a user may have access to a computer with a web browser but not a WEE. That user may use the web browser to connect to a suitable web server, that web server having a WEE. After verifying the user's credentials, the WEE may download and instantiate the user's workspace—perhaps just as a personal computer would, as described herein and elsewhere. Then, the WEE may redirect the user's web browser to a webpage providing a remote desktop of the user's workspace that is now running on the server. The user may interact with his workspace via the remote desktop. At the conclusion of the user's session, all modifications to the virtual disk images 528 of the user's workspace that have not already been committed to data repository 118 may be so committed. A variety of other such examples will be appreciated.

In some embodiments, the WEE may destroy the secured workspace volume 524 more or less on the fly, perhaps in response to a trigger, timeout, expiration, or the like. For example and without limitation, in a secure governmental computing environment, a user may access a secured workspace volume 524 or workspace that automatically self-destructs after a period of time. Also for example and without limitation, a temporary worker or contractor may be granted limited-time access to a secured workspace volume 524 or workspace. That limited-time access may expire at the end of the contactor's term of service. In another example, also without limitation, a traveling worker may be granted access to a secured workspace volume 524 or workspace on a mobile computer. In order to protect against theft of the mobile computer and the secured workspace volume 524 or workspace, the mobile computer may destroy the secured workspace volume 524 or workspace if a certain number of sequential login attempts fail. Still other examples will be appreciated, and all such examples are within the scope of the present disclosure.

The WEE may provide a variety management functions that provide or are related to any and all of the following tasks or modes or operation: machine lockdown; system updates; backups; system and data recovery; mobile computing; disconnected operation; web-based virtual machine management; creation of workspace policies; integration to an enterprise database application; hardware object management; and so on. Any and all of the WEE's management functions may be accessible to all users, to a particular subset or group of users, to an administrator only, and so on.

Machine lockdown may involve creating a new copy-on-write disk image, booting from that disk image, and then discarding the disk image upon shutdown.

System updates may, without limitation, include applying security patches to an operating system or application; installing new software; upgrading an operating system to a new version; reinstalling or installing an operating system; publishing a workspace; bringing a workspace into a known state (e.g., by resetting certain system settings or application settings to known values; by reverting a virtual disk image 528 to a previous, known virtual disk image 528; and so on); distributing a master virtual hard disk image to a plurality of users (as described hereinabove with reference to FIG. 1 and elsewhere); and so on.

In embodiments, creation of workspace policies may include, without limitation, any and all of the following acts: activating and authenticating policies with Microsoft Active Director Integration or another type of user database; changing passwords with Microsoft Active Directory Password Change Proxy; setting a timeout value on one of the client systems 102 or for a secured workspace volume 524; managing encryption settings; determining how long a workspace is allowed to run before requiring a call-back to the management system 108 for verification, updates, or the like; specifying data backup policies; setting wired or wireless resource privileges; defining which users have access to a USB device or USB port; setting user display privileges, such as and without limitation enabling or disabling a built in display or external display port of a personal computer; defining a default setting for workspace execution; specifying a storage location, which may without limitation include a network location of the management system 108, a network location of a network attached storage device, a network location of a network-based storage location, and so on; setting a timeout; setting an expiration; and so on.

In embodiments, integrating with an enterprise database application may include embedding the data repository 118 or a portion thereof within the enterprise database application. In such embodiments, the enterprise database application may include the management system 108.

In embodiments, the hardware object management may include tracking an active hardware configuration, editing a hardware configuration, and so on.

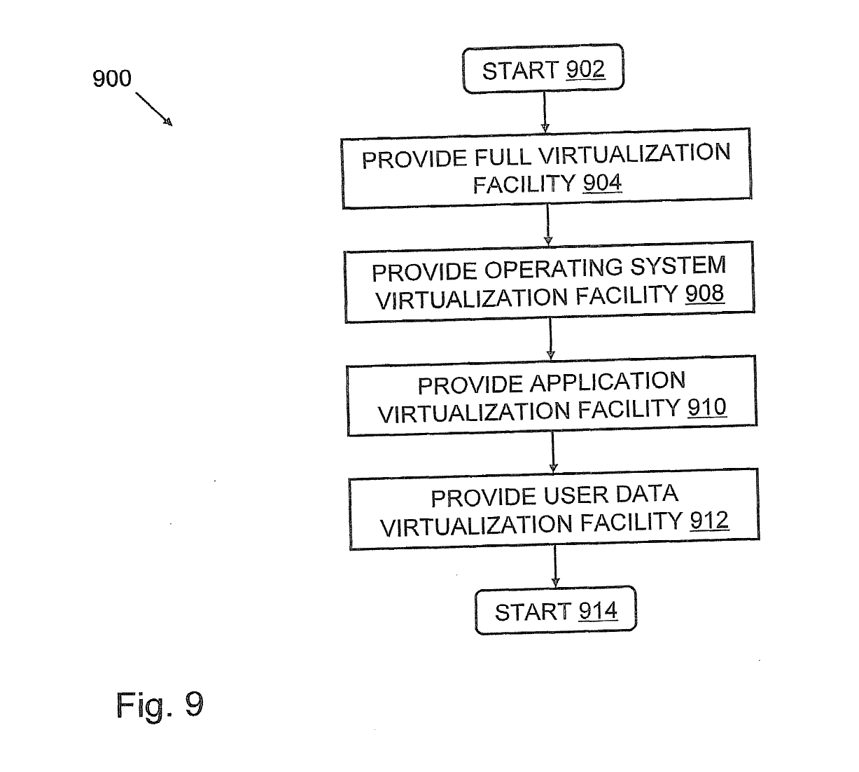

FIG. 9 depicts a method of providing a virtualized workspace. The workspace may be associated with a computer having an operating system. The method 900 begins a block 902 and continues to block 904, where the method 900 provides a full virtualization facility for abstracting the computer's hardware from the operating system and from applications running on the computer. In embodiments, the full virtualization facility may include a WEE. In some embodiments the WEE may use the hypervisor 802. At block 908, the method 900 may provide an operating system virtualization facility for containing and isolating operating system services from each other and applications. In some embodiments, the operating system virtualization facility may include the hypervisor 802. At block 910, the method 900 may provide an application virtualization facility for allowing at least one application to run virtualized on an operating system of the computer. In some embodiments, the application virtualization facility may include the virtual workspace specification 200, or any and all elements thereof. At block 912, the method 900 may provide a user data virtualization facility for containing and isolating user data from the hardware, the operating system and the applications. In some embodiments, the user data virtualization facility may include the device manager emulator of the WEE. The method may end at block 914.

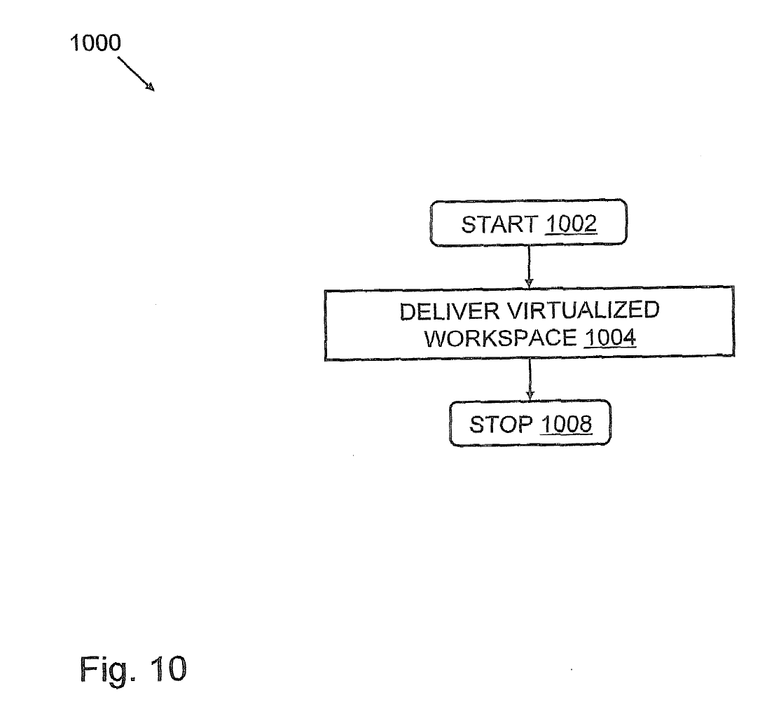

FIG. 10 depicts a method of delivering a virtualized workspace. The method 1000 begins at block 1002 and continues to block 1004, where the method 1000 delivers a virtualized workspace to a computer. The virtualized workspace may include a virtual machine disk image and the computer may be one of the client systems 102. The virtual machine disk image may include the virtual machine image 202. In some embodiments, the virtualized workspace may include an operating system, applications, and end user data encapsulated and packaged as a virtual machine, which may itself be embodied as a secured workspace volume 524. The method may end at block 1008.

In some embodiments, delivering the virtualized workspace may further comprise the following: providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications. As described hereinabove and elsewhere, the full virtualization facility may abstract a computer's hardware from software running on the computer such as an operating system and applications. As described hereinabove and elsewhere, the operating system virtualization facility may contain and isolate operating system services from each other and applications. As described hereinabove and elsewhere, the application virtualization facility may allow at least one application to run virtualized on an operating system of the computer.

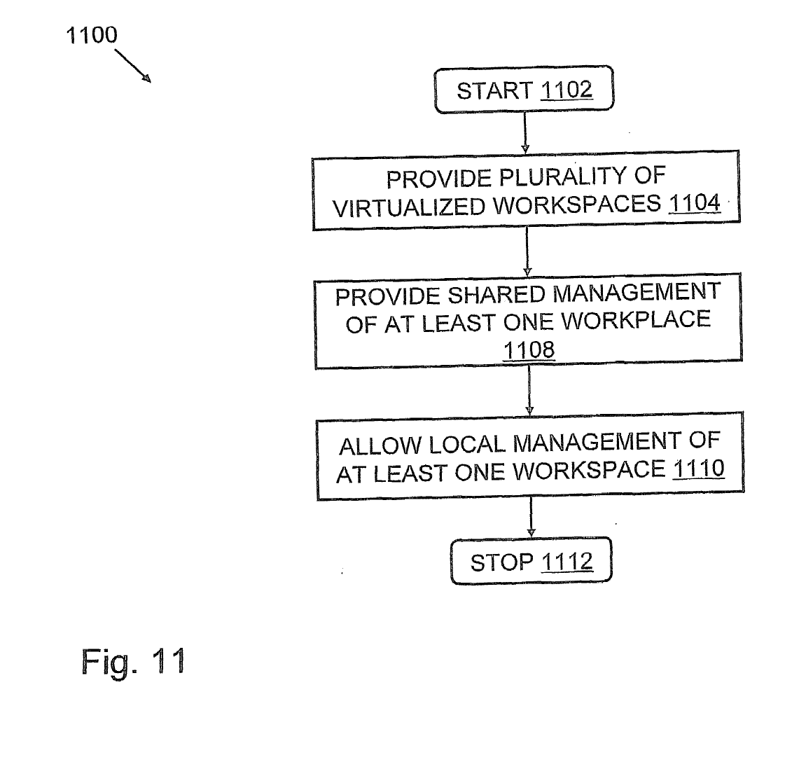

FIG. 11 depicts a method of providing security for virtualized workspaces. The method 1100 begins at block 1102 and continues to block 1104, where the method 1100 provides a plurality of virtualized workspaces for operating on the same computer, each workspace embodied in at least one virtual machine disk image. At block 1108, the method 1100 provides shared management of at least one workspace, using at least one root disk image adapted for use by a plurality of users of a plurality of centrally managed desktops. At block 1110, the method 1100 allows local management of at least one other workspace, the management of the other workspace not being subject to at least one constraint applicable to the centrally managed workspace. The method may end at block 1112.

It follows that any one of the client systems 102 may have both a centrally managed workspace and a locally managed workspace. These workspaces may co-exist and run substantially simultaneously in complete isolation from one another. It should be understood that both workspaces might have access to shared resources such as a keyboard, audio output, graphics processing unit (GPU), CPU, or the like, and that the client system's 102 WEE or other virtualization component may manage this access.

For example and without limitation, a user may have a workspace for work-related use and workspace for home-related use. An administrator at the user's place of work may centrally manage the workspace for work-related use. The administrator may apply a constraint to this workspace, the constraint limiting the user's ability to install an application into the workspace. This constraint may not apply to the home-related workspace, which the user locally manages. A variety of other such examples will be appreciated.

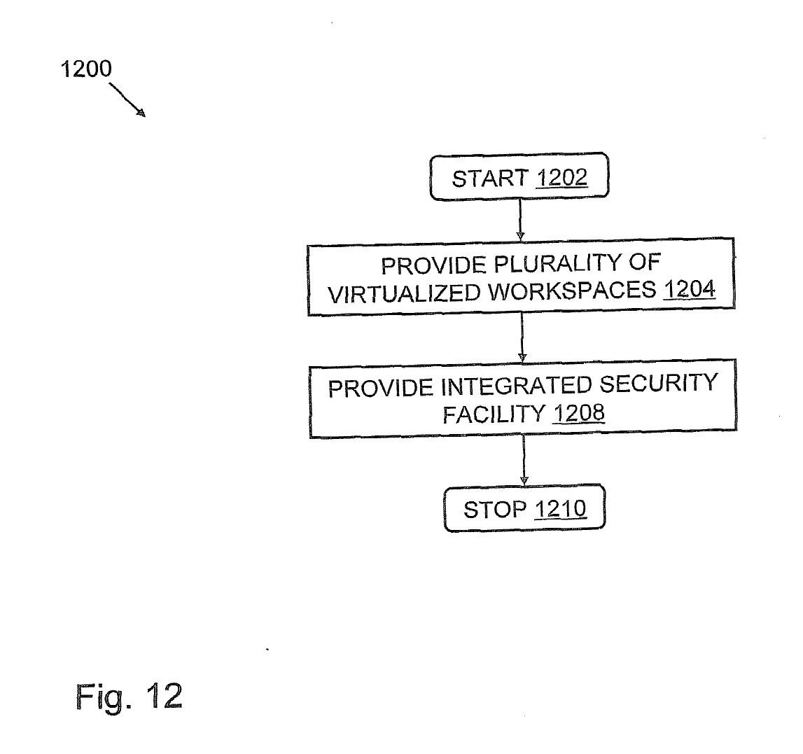

FIG. 12 depicts a method of embodying a virtualized workspace. The method 1200 begins at block 1202 and continues to block 1204, where the method 1200 provides a plurality of virtualized workspaces for operating on the same computer, each workspace embodied in at least one a virtual machine disk image. At block 1208, the method 1200 provides an integrated security facility for managing security with respect to at least a plurality of the virtualized workspaces. The method may end at block 1210.

In some embodiments the integrated security facility may allow full management of security of an operating system from outside the operating system. In some embodiments, the integrated security facility may allow management of the memory of an operating system from outside the operating system. In some embodiments, the integrated security facility may allow management of an operating system from outside the operating system using the hypervisor 802.

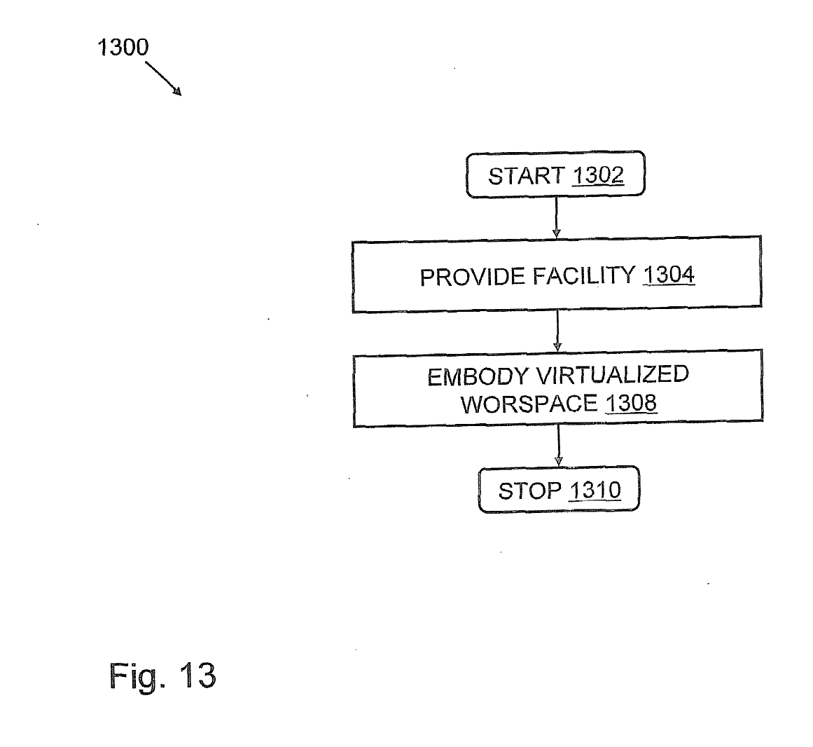

FIG. 13 depicts a method of embodying a virtualized workspace. The method 1300 begins at block 1302 and continues to block 1304, where the method 1300 provides a facility for managing a virtualized workspace adapted to operate on a computer. In embodiments, the facility for managing a virtualized workspace may include the control domain or any component thereof. At block 1308, the method 1300 embodies the virtualized workspace as a set of virtual disk images to facilitate transporting the workspace to a different computer for operation of the workspace without necessitating installation of an operating system component on the second computer. Such an embodiment of the virtualized workspace may include the secured workspace volume 524, any and all of the virtual disk images 528 therein, and so on. The method may end at block 1310.

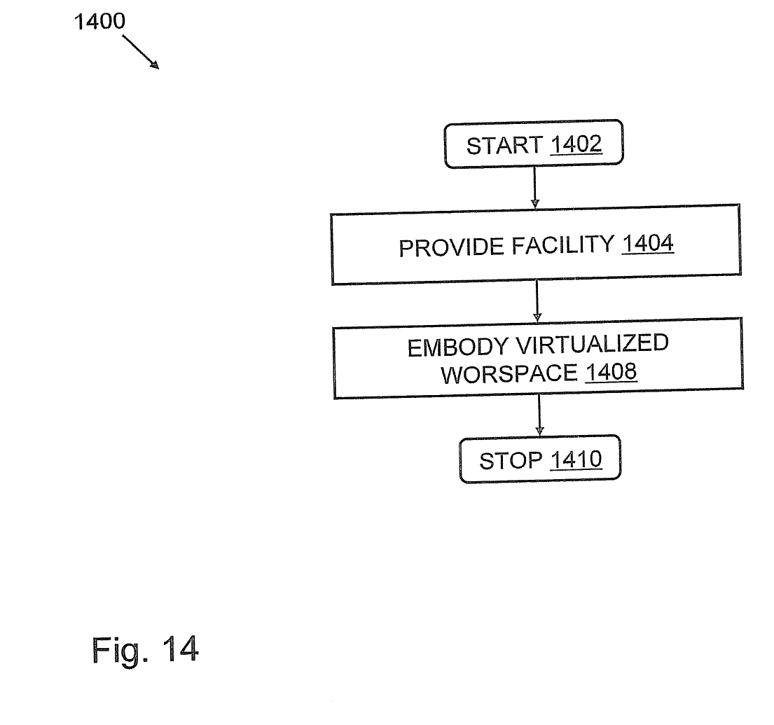

FIG. 14 depicts a method of providing a virtualized workspace. The method 1500 begins at block 1402 and continues to block 1404, where the method 1400 may provide a facility for managing a virtualized workspace adapted to operate on a computer. At block 1404, the method may embody the virtualized workspace as a set of virtual disk images to facilitate transporting the workspace to a different computer independent of the configuration of the hardware of the second computer. In some embodiments, the second computer may include a control domain 514 or the like that virtualizes the hardware of the second computer, providing a virtual hardware for which the workspace is adapted and on which the workspace may be executed. The method may end at block 1408.

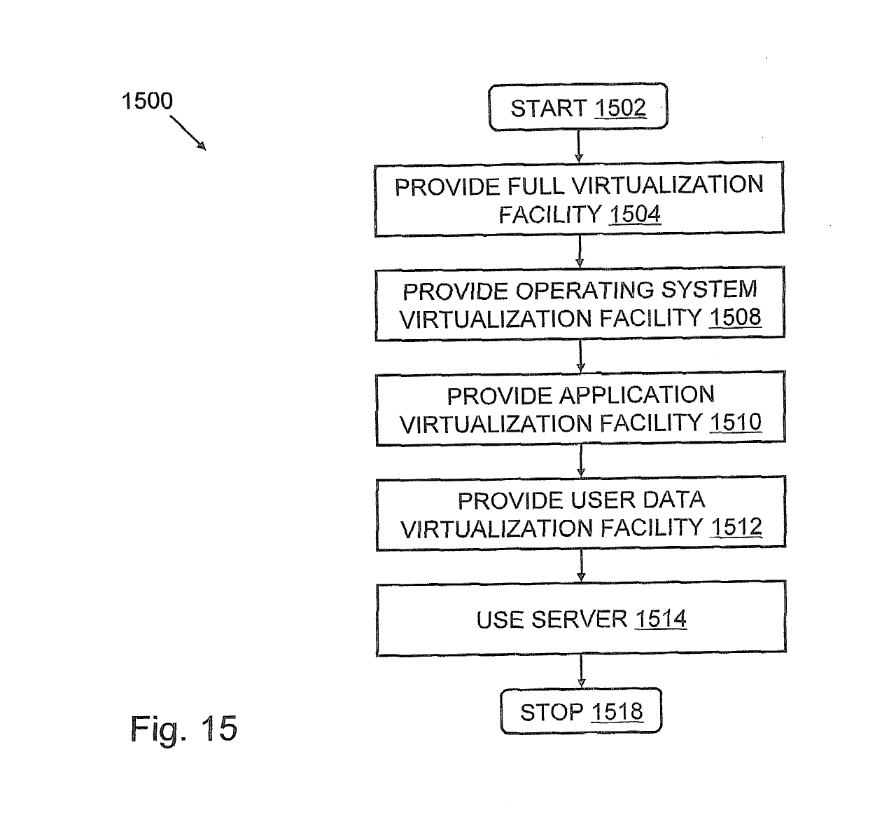

FIG. 15 depicts a method of providing a virtualized workspace. The virtualized workspace may be associated with a computer having an operating system. The method 1500 begins a block 1502 and continues to block 1504, where the method 1500 may provide a full virtualization facility for abstracting the computer's hardware from the operating system and from applications running on the computer. At block 1508, the method 1500 may provide an operating system virtualization facility for containing and isolating operating system services from each other and applications. At block 1510, the method may provide an application virtualization facility for allowing at least one application to run virtualized on an operating system of the computer. At block 1512, the method 1500 may provide a user data virtualization facility for containing and isolating user data from the hardware, the operating system and the applications. At block 1514, the method 1500 may use a server to provide remote access to a virtualized workspace on a client device. In some embodiments, the server may include the management system 108 and the client device may be one of the client systems 102. The method may end ay block 1518.

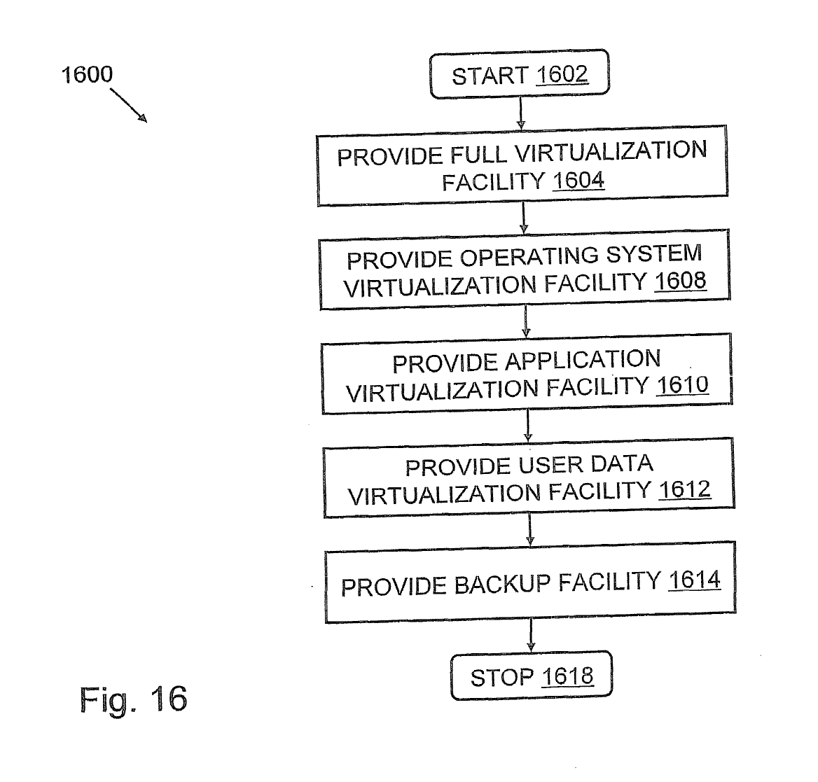

FIG. 16 depicts a method of providing virtualized workspaces. The virtual workspaces may be associated with a computer having an operating system. The method 1600 begins at block 1602 and continues to block 1604, where the method 1600 may provide a full virtualization facility for abstracting the computer's hardware from the operating system and from applications running on the computer. At block 1608, the method 1600 may provide an operating system virtualization facility for containing and isolating operating system services from each other and applications. In some embodiments the operating systems services may include a graphics display driver, an audio device driver, a peripheral driver, a process scheduler, a disk driver, and so on. It will be understood that a variety of operating system services are possible. At block 1610, the method 1600 may provide an application virtualization facility for allowing at least one application to run virtualized on an operating system of the computer. At block 1612, the method 1600 may provide a user data virtualization facility for containing and isolating user data from the hardware, the operating system and the applications. And, at block 1614, the method 1600 may provide a backup facility to allow instant, hardware-agnostic access to the virtualized workspace. In some embodiments the backup facility may include a remote backup facility, such as and without limitation the management system 108 or the data repository 118 thereof. In some embodiments the backup facility may include a local backup facility, such as and without limitation a virtual disk image 528, a storage devices attached to the computer, and so on. It will be understood that a variety of backup facilities are possible. The method 1600 may end at block 1618.

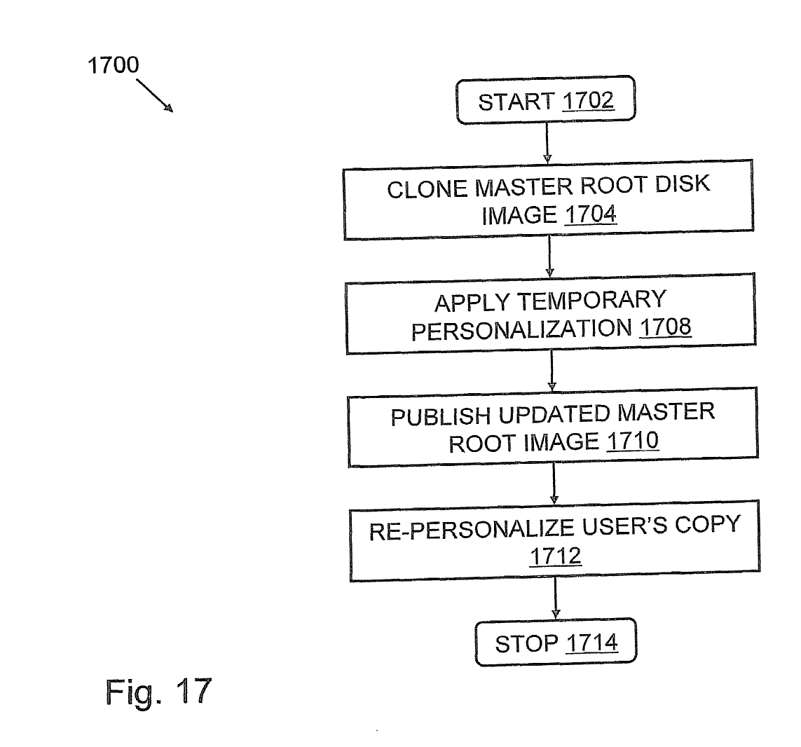

FIG. 17 depicts a method of updating a plurality of virtualized workspaces. The method 1700 begins at block 1702 and continues to block 1704, where the method 1700 clones a master root disk image. At block 1708, the method 1700 may apply temporary personalization to a clone of the master root disk image. In some embodiments, the clone of the master root disk image may include the unsecured bootloader volume 512 and the personalization may include an updated key 510. At block 1710, the method 1700 may publish the updated master root image to a plurality of users, wherein publishing omits at least a portion of the personalization applied to the clone of the master root disk image. At block 1712, the method may, based at least in part on the clone, re-personalize a user's copy of the published master root disk image for use on the user's local computer. Re-personalizing the user's copy may include modifying a parameter embodied in the master root disk image. In embodiments, the parameter may include a computer name, a user account identifier, a system identifier, a hard variable of an operating system, and so on. In some embodiments, re-personalizing the user's copy may include providing a seal 508 that is adapted, as described hereinabove and elsewhere, to be broken by the local computer's TPM 504. The method may end at block 1714.

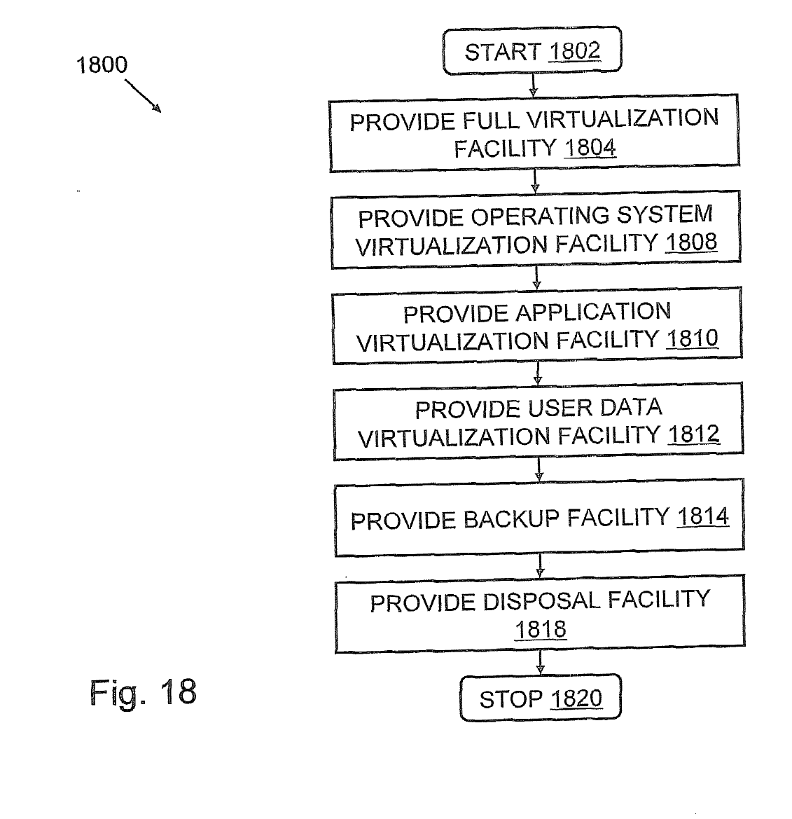

FIG. 18 depicts a method of providing a virtualized workspace. The virtualized workspace may be associated with a computer having an operating system. The method 1800 begins at block 1802 and continues to block 1804, where the method 1800 provides a full virtualization facility for abstracting the computer's hardware from the operating system and from applications running on the computer. At block 1808, the method 1800 may provide an operating system virtualization facility for containing and isolating operating system services from each other and applications. At block 1810, the method 1800 may provide an application virtualization facility for allowing at least one application to run virtualized on an operating system of the computer. At block 1812, the method may provide a user data virtualization facility for containing and isolating user data from the hardware, the operating system and the applications. At block 1814, the method 1800 may provide a backup facility to allow instant, hardware-agnostic access to the virtualized workspace. At block 1818, the method 1800 may provide a disposal facility for disposing of the entire virtualized workspace. In some embodiments, the disposing may be in response to a user action, upon expiration of a time period, based on a policy, triggered upon violation of a policy, or the like. The method may end at block 1820.

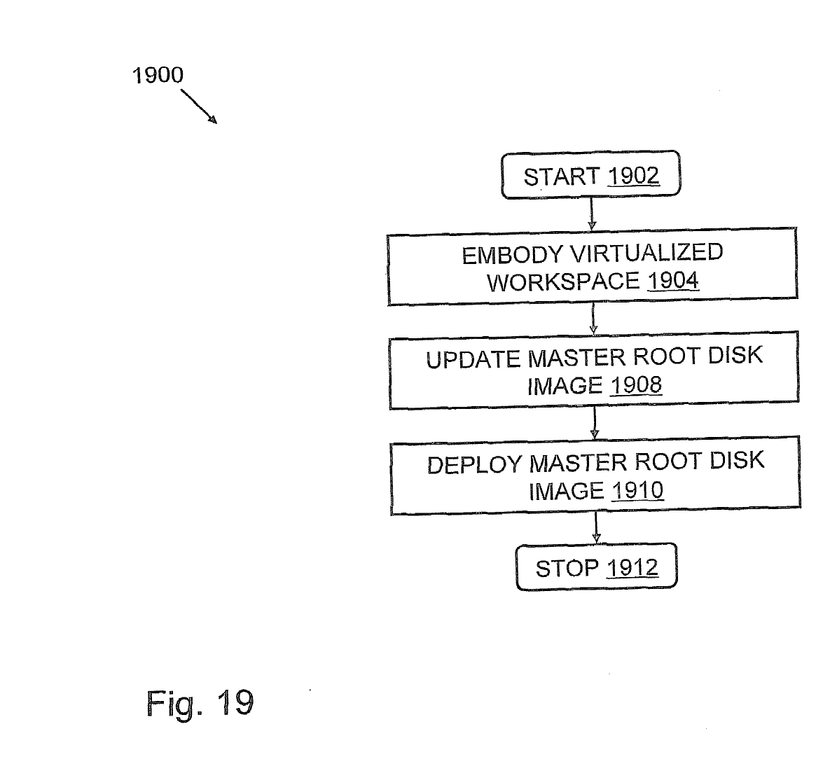

FIG. 19 depicts a method of updating a virtualized workspace. The virtualized workspace may be associated with a computer. The method 1900 begins at block 1902 and continues to block 1904, where the method 1900 embodies a virtualized workspace in a master root disk image. At block 1908, the method 1900 updates the master root disk image. At block 1910, the method 1900 deploys the master root disk image to a plurality of computers. The method may end at block 1912.

In some embodiments virtualizing the workspace may include providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications.

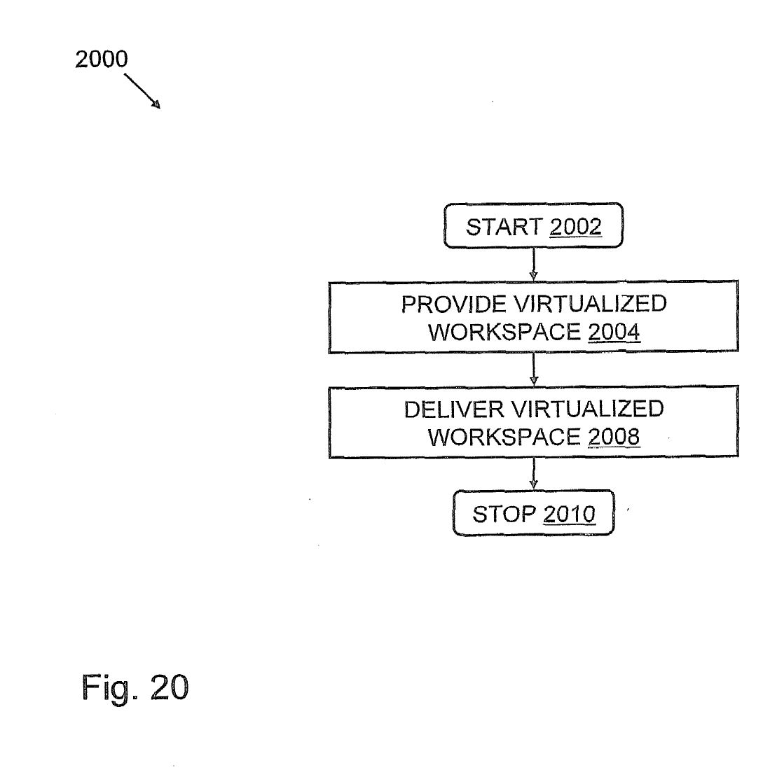

FIG. 20 depicts a method of delivering a virtualized workspace. The method 2000 begins at block 2002 and continues to block 2004, where the method 2000 provides a virtualized workspace. At block 2008, the method 2000 may deliver the virtualized workspace by streaming data from a central computer to a remote computer for use of the virtualized workspace on the remote computer. In some embodiments the central computer may include the management system 108 and the remote computer may include one of the client systems 102.

In some embodiments virtualizing the workspace may include providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications.

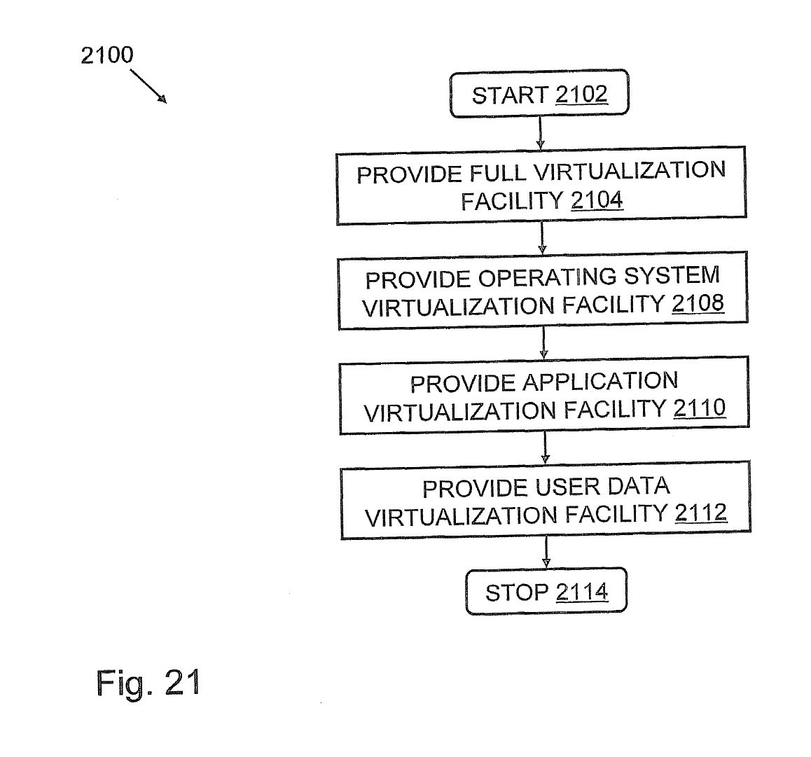

FIG. 21 depicts a method of providing a virtualized workspace. The virtual workspace may be associated with a mobile computer having an operating system. The method 2100 begins at block 2102 and continues to block 2104, where the method 2100 provides a full virtualization facility for abstracting the computer's hardware from the operating system and from applications running on the computer. At block 2108, the method 2100 provides an operating system virtualization facility for containing and isolating operating system services from each other and applications. At block 2110, the method 2100 provides an application virtualization facility for allowing at least one application to run virtualized on an operating system of the computer. At block 2112 the method provides a user data virtualization facility for containing and isolating user data from the hardware, the operating system and the applications. The method may end at block 2114.

The mobile computer may be one of client systems 102. In embodiments, the mobile computer may include a laptop computer, a handheld computer, a smart phone, a point of sale device, or the like. It will be understood that a variety of embodiments of the mobile computer are possible.

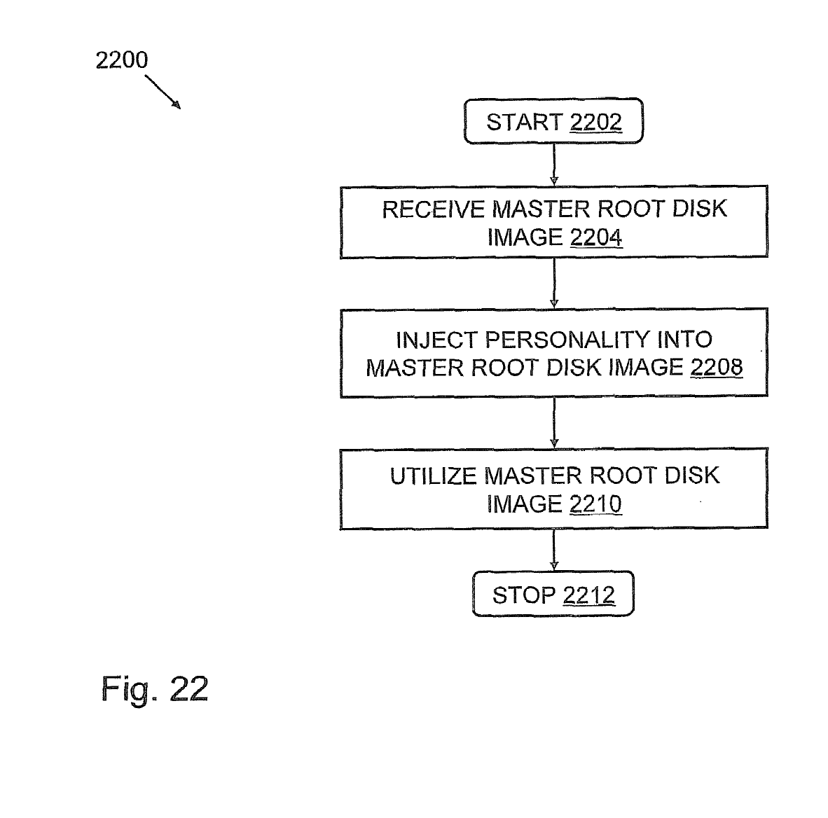

FIG. 22 depicts a method of personalizing a master root disk image. The method 2200 begins at block 2202 and continues to block 2204, where the method 2200 receives a master root disk image. Then, at block 2208 the method 2200 injects a personality into the master root disk image. This is described in detail hereinabove and elsewhere. At block 2210 the method 2200 utilizes the master root disk image. Without limitation, utilizing the master root disk image may include mounting the master root disk image, running an application on the master root disk image, booting from the master root disk image, accessing data that is stored within the master root disk image, and so on. The method may end at block 2212.

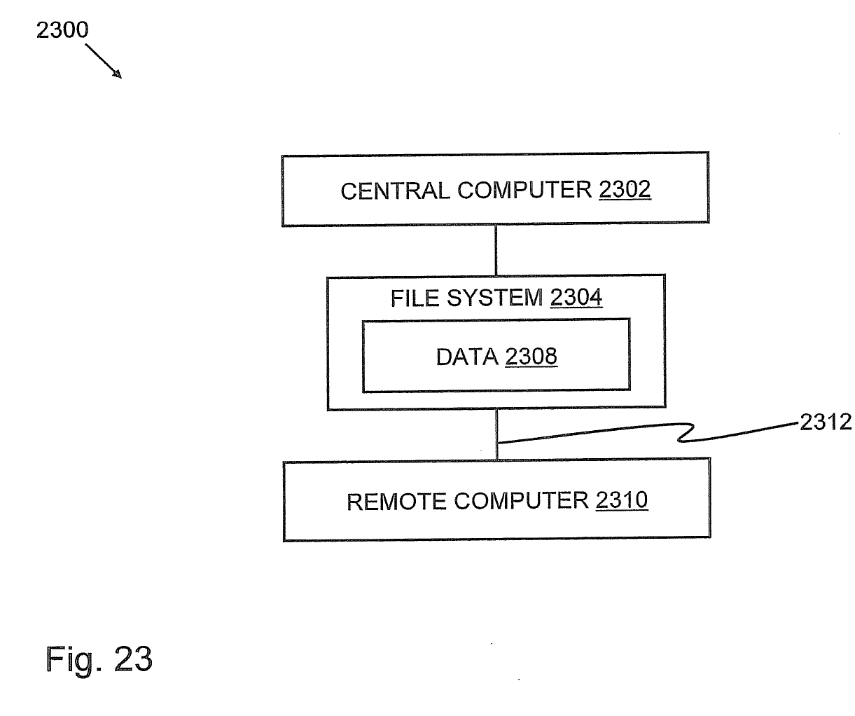

FIG. 23 depicts a system that provides a virtualized workspace. The system 2300 includes a central computer 2302, a file system 2304 that is operatively coupled to the central computer 2302, and data 2308 stored in the file system 2304. Also depicted are a remote computer 2310 and an operative coupling 2312 between the remote computer 2310 and the file system 2304.

The central computer 2302 may include the computing center 114. The file system 2304 may include the data repository 118. In embodiments, the operative coupling between the file system 2304 and the central computer 2302 may include an iSCSI connection, a Fibre Channel connection, a file sharing protocol running over an Internet Protocol network, or the like. It will be understood that a variety of operative couplings are possible.

The data 2308 may include any and all of the data described herein and elsewhere. This may include, without limitation, a workspace, user data 124, a system disk image 128, a virtual workspace specification 200 or the elements thereof, an unsecured bootloader volume 502 or the elements thereof, and so on and so forth. In embodiments, the data 2308 may be adapted to provide a virtualized workspace on the remote computer 2310 when run on the remote computer 2310.

The remote computer 2310 may be any one of the client systems 102. The operative coupling 2312 between the remote computer 2310 and the file system 2304 may include the network 104. It should be understood that the operative coupling 2312 may also include any and all suitable protocols for communicating between the remote computer 2310 and the file system 2304. Such protocols may include iSCSI, Network File System, a peer-to-peer protocol, and so on. A variety of such protocols will be appreciated.

From time to time, the remote computer 2310 may access or modify the data 2308. Also from time to time, the central computer 2302 may access or modify the data 2308.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

The invention claimed is:

1. A method for updating a plurality of virtualized workspaces, comprising:
cloning a master root disk image;
applying temporary personalization to the master root disk image clone;
publishing the master root image clone to a plurality of users, wherein publishing omits at least a portion of the personalization; and
based at least in part on the clone, re-personalizing a user's copy of the published master root disk image clone for use on the user's local computer.
